(19) United States
(12) Patent Application Publication
(10) Pub. No.: US 2004/0025186 A1
(43) Pub. Date: Feb. 5, 2004

(54) System and method for managing media

(76) Inventors: Charles A. Jennings, Kansas City, MO (US); Donald H. Bate, Plano, TX (US)

Correspondence Address: James M. Stipek, Esq., Lathrop & Gage L.C., Suite 2800, 2345 Grand Boulevard, Kansas City, MO, 64108, US

(21) Appl. No.: 09/766,278

(22) Filed: Jan. 19, 2001

(51) Int. Cl. H04N 7/173; G06F 3/00; H04N 5/445; G06F 15/16

(52) U.S. Cl. 725/93; 725/87; 725/98; 725/58; 709/219; 709/227

(57) ABSTRACT

A system and method for streaming media comprises a stream routing processor, a switch controller, a stream caster, media storage, and a packet switch. The stream routing processor determines if the stream caster is configured to stream requested media. The switch controller monitors the status of all devices and events and notifies the stream routing processor if an error or alarm condition occurs. The stream caster streams media upon receiving a valid reservation identification. The media storage stores the media for retrieval by the stream caster. The packet switch transmits signaling and media from the system and between devices of the system, including the stream routing processor, the switch controller, the stream caster, and the media storage.

### FIELD OF THE INVENTION

The present invention is related to the fields of management and administration of a digital media streaming distribution and viewer session management.

### BACKGROUND OF THE INVENTION

Real time transport of digital audio, video, and other data commonly referred to as “digital media” may be manipulated and rendered using computers and/or digital appliances, such as a set top box. A digital appliance is a horizontal product based on electronics technology that performs functions and uses a computer and/or telecommunication network or other computer network to access, retrieve, interact with, report, and/or handle information or media.

As computers and computer based appliances gain in popularity, the demand for digital media streaming services also increases. This occurs because digital media streaming can be used to create enhanced consumer and business services. For example, a manufacturer of a refrigerator may install a digital appliance that connects the refrigerator's digital appliance to the Internet. A consumer can use the digital appliance to receive digital audio/video explaining how to prepare a favorite recipe.

The digital appliances and other computers can use real time media streaming services to render media while it is streamed from the media's server computer. Real time media streaming often is preferred over pure downloading since media streaming permits a consumer to view video and/or hear the audio shortly after it is requested instead of waiting for a delayed download of the complete media and a subsequent playing of the media by the digital appliance.

Real time media streaming is difficult to implement on diverse networks, such as the internet, corporate private networks, corporate intranets, and other packet based networking solutions. This is because real-time media applications typically are resource intensive and lack sufficient state control models to ensure proper quality of service. Enhanced media streaming services generally compound the difficulties because multiple digital media streams are transmitted instead of a single digital media stream. In these instances, current technologies treat each digital media stream as an individual session with little or no association to the viewer. Moreover, existing digital media streaming devices focus on the technical transmission delivery of media, and place little control over the viewer management and media content management.

As a result, companies wishing to use digital streaming services currently face difficult tasks of managing diverse sets of equipment and software in order to provide consumers services that meet their needs. In addition, the ability to accurately track and bill consumers to whom services are provided is lacking. An improved system and method are needed to focus on viewer and media content management while simultaneously delivering a media stream having high quality. The present system and method meet those needs.

### SUMMARY OF THE INVENTION

The present invention is directed to a system for streaming media comprises a stream routing processor and a stream caster. The stream routing processor is configured to receive reservation data comprising a valid reservation identification and to transmit the valid reservation identification. The stream caster is configured to receive a reservation identification, to receive the reservation data identifying the valid reservation identification from the stream routing processor, to validate the reservation identification using the valid reservation data, and, if valid, to stream at least partially the requested media.

The present invention also is directed to a switch for streaming media comprising a stream routing processor and a stream caster. The stream routing processor is configured to receive signaling inquiring if the switch can stream requested media, to determine if the switch is configured to stream the requested media, and, if so to acknowledge the inquiry and to receive reservation data comprising a valid reservation identification. The stream caster is configured to receive a reservation identification, to receive from the stream routing processor the reservation data identifying the valid reservation identification, to validate the reservation identification using the valid reservation data, and, if validated, to stream at least partially the requested media.

Further, the present invention is directed to a switch for streaming media to a viewer comprising a stream caster and a stream routing processor. The stream caster is configured to accept a session from the viewer to stream at least partially the requested media upon receiving and validating a reservation identification using a valid reservation identification. The stream routing processor is configured to determine if the stream caster is configured to stream the requested media, and, if so, to receive reservation data comprising a valid reservation identification and to transmit the valid reservation identification to the stream caster.

In addition, the present invention is directed to a switch for streaming media to a viewer comprising a stream caster, a stream routing processor, and a switch controller. The stream caster is configured to accept a session from the viewer to stream at least partially the requested media upon receiving and validating a reservation identification using a valid reservation identification. The stream routing processor is configured to determine if the stream caster is configured to stream the requested media, and, if so, to receive reservation data comprising a valid reservation identification and to transmit the valid reservation identification to the stream caster. The switch controller is configured to monitor the stream caster and to notify the stream routing processor of a status of the stream caster.

Further yet, the present invention is directed to a switch for streaming media to a viewer comprising a stream caster configured to receive a valid reservation identification, the stream caster comprising a media server configured to stream the requested media. The stream caster further comprises a signal proxy configured to accept a session based on validating a reservation identification received from the viewer and to communicate signaling between the viewer and the media server if the session is accepted. The stream caster further comprises a stream proxy configured to transmit media streamed from a media server to a viewer and to receive signaling from a viewer and to transmit the signaling to a media server.

The present invention further is directed to a method for streaming media from a switch comprising determining if a stream caster is configured to stream requested media and receiving reservation data comprising a valid reservation identification and transmitting the valid reservation identification to the stream caster. A session to stream at least partially the requested media is accepted upon receiving and validating a reservation identification using a valid reservation identification.

Still further, the present invention is directed to a method for streaming media from a switch comprising receiving at a stream caster reservation data comprising a valid reservation identification. An attempted session to stream requested media is terminated upon receiving and invalidating a reservation identification using a valid reservation identification.

### BRIEF DESCRIPTION OF THE DRAWINGS

FIG. 1 is a block diagram of a streaming system in accordance with an embodiment of the present invention.

FIG. 2 is a block diagram of a switching system in accordance with an embodiment of the present invention.

FIG. 3 is a block diagram of a signal routing processor in accordance with an embodiment of the present invention.

FIG. 4 is a block diagram of a switch controller in accordance with an embodiment of the present invention.

FIG. 5 is a block diagram of a stream caster signal wrapper subsystem in accordance with an embodiment of the present invention.

FIG. 6 is a block diagram of a stream caster log data storage and transport subsystem in accordance with an embodiment of the present invention.

### DETAILED DESCRIPTION

Media streaming, both live and on-demand, provides the optimal environment for viewers to experience multimedia by establishing a logical, one-to-one connection between the media and the audience (a “session”). This enables a rich media, interactive experience and is the foundation for a reliable streaming service platform. Media may include audio, video, and other data. Media may include one or more media clips, a part of a media clip, a presentation as defined below, or part of a presentation. A session may include an internet protocol session and/or a broadband connection. For simplicity, the word session may be used in some instances to mean only an internet protocol session, only a broadband connection, or both, depending on verbiage.

The system of the present invention controls the distribution of streaming media through enhanced communications between communication devices coupled over disparate packet networks, such as the Internet, intranets, virtual private networks, cable systems, frame relay networks, asynchronous transfer mode (ATM) networks, and/or satellite networks. The present invention implements control features, such as real time routing of a request for media service, enforcement of media owner's rights and distribution criteria, real time audience event reporting, and session detail accounting and traceability.

The system of the present invention uses a reservation identification to track media streaming throughout the network. A reservation identification, such as a reservation number, is assigned to a request for media. All communication devices in the network use the reservation identification to provide services for the media. Records later are produced and collated with the reservation identification. This enables the system to provide media from multiple sources, track the provision of media from multiple sources, and generate records and billing that accurately depict the media streaming service. This is an advance over prior systems.

The system of the present invention uses a reservation state model (“state model”). The state model tracks the progress of a viewer request across several different devices and processes to enable the viewer to receive a quality presentation of media. The state model allows a data collection process to occur from the time a request for media is processed and a reservation for the request is generated through and after the time the requested media is streamed to the viewer.

The state model enables dynamic routing of media requests from the viewer, and it monitors when the viewer has suspended the viewing session. The monitoring, recordation, and use of the reservation state model and the state changes thereof are a significant advance over existing approaches that are limited to monitoring a state for only a single media server to a single viewer for a single media clip. The prior approaches cannot collect information prior to a session being established, and this can represent a significant security risk in addition to significantly limiting the ability to provide media from a single device.

However, the present system is not limited to obtaining information only after the session or connection begins. Contrarily, the present system can obtain and gather information for a state prior to, during, and after a session or a connection. For example, a viewer wishing to participate in a video conference may enter the conference code at the time the viewer makes the reservation. The viewer requesting the reservation starts the state model on the switch management system of the present invention. The viewer may be asked to enter a conference code for the reservation which is processed to determine its validity. The reservation would then pass to the routing processor system where the state model completes the routing of the request.

The state model monitors the progress of selecting the right switch to process the event. If no switch resources are available, the state model may choose to queue the reservation until a resource becomes available. Once the routing processor determines to which switch to send the viewer request, the state model awaits the viewer session or connection. When the viewer connects, the viewer may then be asked to enter a second authorization code at the time the media is being retrieved. This second authorization code may be used to identify the person as the chair person, a participant, what company they represent, or other data relevant to the reservation. When the media for the reservation is streaming, the state model identifies the reservation in an active state. If the viewer pauses the conference, the session is suspended until a request to be reconnected is received. Once the viewer tears down the session, the resources are returned to their idle states.

As can be seen from the above example, the state model of the present invention tracks states throughout a reservation and streaming process over multiple devices. In addition, each such device retains a state model for the events and states within that device. This reservation state model enables multiple devices to be used to provide media, enables multiple devices to be substituted in the event of an error or alarm, and enables states and streaming events and records to be reconciled with each other to identify a complete streaming event.

A media stream may comprise signaling that can be transmitted in-band in a streaming session or out of band in a signaling session. The signaling may comprise a client's information, such as a digital media player type, the desired data communication rate, whether the media stream is to be transported over a broadband connection or inband, and/or whether the media stream is to be communicated over a private network link. Stream signaling comprises information that facilitates the digital stream processing. Stream signaling may comprise, for example, information describing the viewer digital media player software version, the desired content reference, and the desired quality of service. Stream signaling is accomplished through various standard protocols such as real time streaming protocol (RTSP), real time protocol (RTP), session initiation protocol (SIP), and the International Telecommunications Union (ITU) H.323 series protocols.

Signaling and signaling sessions are used to transport reservation requests and other signaling messages. The term “signaling” when used with “session” herein means the transmission and/or reception of signaling to or from a viewer or a device in the streaming system. Signaling may include a viewer's choices of content selection, desired communication speed, desired digital media format, and statistical data on one or more simultaneous streaming sessions. A signaling session typically is associated with out-of-band communications, such as with a logical virtual circuit connection, but can be associated with logical in-band sessions. Virtual private networks (VPNs) may be used to transport stream signaling and control information for a signaling session. VPNs can include the Internet, intranets, local area networks (LANs), wide area networks (WANs), frame relay networks, asynchronous transfer mode (ATM) networks, or other networks.

Streaming sessions are used to transport media, other media player process communications, including in-band signaling, and other device information, to and from a viewer and other communication devices. The term “streaming session” as used herein means the transmission of media over a packet based network to a viewer or to another communication device. For example, a streaming session can carry media to a set top box for display on one or more televisions or to a media player associated with a web browser.

The system is configured to stream multiple sessions simultaneously and/or in parallel. For example, a hearing impaired person using a viewer may request for a news item and request for a signing interpreter. In this instance, two steaming sessions exist, and they both operate on the viewer. The first session is the news clip, and the second session is another person hand signing what the news clip announcer is stating.

There are multiple uses for parallelism in streaming media. Media can be streamed with a different, customized sound track, such as a language preference. This typically is synchronized.

Also, different media can be streamed in parallel. This can occur with business presentations and may be an option with the hand signing example above. These typically are synchronized.

Different videos that are semi-synchronized may be streamed so that a viewer can back up, repeat, or skip forward on two or more videos independently. For example, a viewer may have a talking head in a business presentation, but the video presentation of a collateral video/audio material may occur in a different stream. The viewers would be allowed to backup and review previous collateral video material without disrupting the rest of the presentation.

In addition, independent videos may be streamed from a source. For example, a source may customize a presentation to be used in a world news feed and a financial news feed.

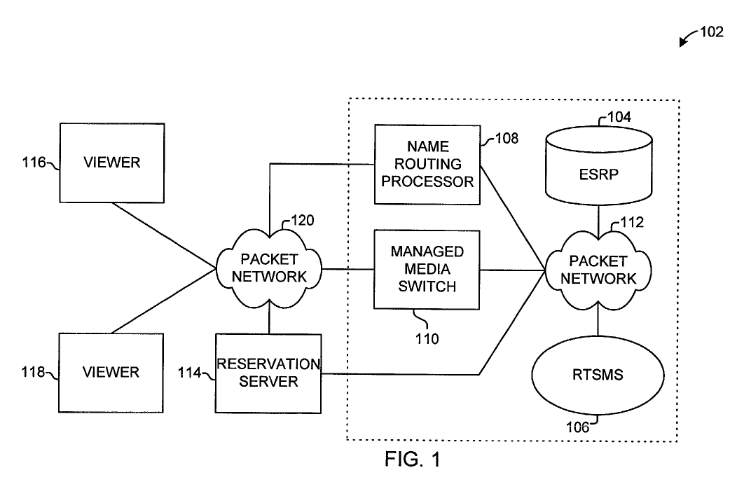

FIG. 1 depicts an exemplary embodiment of a streaming system of the present invention. The streaming system 102 of FIG. 1 comprises a service processor, a management system, a routing processor, and a media switch, such as an enhanced service routing processor (ESRP) 104, a real time switch management system (RTSMS) 106, a name routing processor (NRP) 108, and a managed media switch (MMS) 110, respectively, each communicating through a packet network 112. A reservation server 114 may communicate with the RTSMS 106 via the packet network 112, and one or more viewers 116 and 118 may communicate with the NRP 108, the MMS 110, and/or the reservation server 114 via a packet network 120.

The ESRP 104 enables media owners to place the media on the ESRP for distribution to various switches, such as to various multimedia switches in the streaming system 102. The ESRP 104 allows each media owner to create a list of media, including one or more different types of media or one or more different media clips, and to create media rules to determine the sequence in which the media clips are to be streamed, where the media clips are to be placed, and, in some instances, to whom the media clips can be transmitted.

Media rules may include age restrictions, restrictions for geographic locations, time restrictions, and other media rules. The media list and the media rules that govern the transmission of the media list are called a presentation. The presentation includes the media name(s), the media rules provided by the media owners, and the network distribution rules provided by the packet network supplier. Network distribution rules are defined by a network operator to manage capacity, load, bandwidth, switch and other resource events, including resources for sessions and connections. For example, a presentation can be configured to stream ten minutes of a sitcom based media, insert an advertisement, and then return to the sitcom based media show and may be restricted to 30 viewing frames per second by the network supplier.

The ESRP 104 also allows a media owner and/or a publishing agent of the owner (hereafter “media owner”) to generate rules that define who will be billed or credited when media is transmitted to a viewer or another device and the terms of the bill or credit. For example, a media owner may have a contract with a service provider, and the service provider will share in the revenue generated by viewers viewing the content. Alternately, the media owner may have to pay the service provider for use of an amount of bandwidth when the media is transmitted. In addition, part of the media sent to a viewer may include advertisements, and the media owner can define a rule to bill the advertising entity a dollar amount each time the media is transmitted.

The rules also can identify any restrictions or other customizations, such as geographic or age restrictions, preferred language, or substitutions on the streaming of the presentations. For example, if a football game is a presentation, the game may be blocked from a specific region when the streaming is free, but not blocked if the game is part of a subscription or Pay Per View service. The media owner would generate two or more different orders for the same presentation, and a viewer 116 or 118 would be blocked or not blocked from the presentation depending on which order the viewer was attempting to use. The rules that govern entities, methods, and terms for billing or crediting based on a transmitted media presentation, and any other settlement rules governing the presentation are known as an order.

The ESRP 104 publishes presentations when the presentations and the orders for the presentations are complete. Publishing is the act of making a presentation available on the streaming network 102 for distribution to one or more viewers via a switch, such as the MMS 110. Thus, when a presentation and its order are complete, the ESRP 104 may transmit the media identified in the presentation to one or more switches, such as the MMS 110, according to one or more media rules so that the presentation is available to be streamed to a viewer. The ESRP 104 also publishes the presentations, including a presentation identification, a media list for the presentation, and the media rules for the presentation, to the RTSMS 106.

One or more ESRP devices may exist in the streaming system 102. One ESRP is depicted in FIG. 1 for clarity.

The RTSMS 106 accepts presentations and their respective orders from the ESRP 104 when the presentations are published. The RTSMS 106 determines the switches or other communication devices on which the presentations reside. The RTSMS 106 receives the media list, the media rules, the presentation identification, and any associated orders for the presentation for the ESRP 104.

The RTSMS 106 receives initial signaling from a viewer 116 or 118. This initial signaling may be routed to the RTSMS 106 via a reservation server 114 or another type of communication device. The initial signaling from the viewer 116 or 118 typically is a request for media.

The RTSMS 106 processes the signaling to determine if the requested media is available in a presentation and if the presentation has restrictions applied by the media owner and/or network operator and locates an NRP 108 within the streaming system 102 that is capable of processing the viewer's request. The RTSMS 106 then generates a customized play list for the requested presentation to the viewer. A play list is a list of named media references, such as a universal resource locator (URL), or other media items that are to be streamed to the viewer 116 or 118. The play list may include the requested media, such as one or more media clips, and additional media, such as one or more advertisements, either as media clips, banner advertisements, or other types of advertisements. The play list is formatted as the output of the presentation publication process and is formatted for the language/format of the viewer 116 or 118 media file. For example, a viewer 116 or 118 using the Real Network's Real Player would require a SMIL file based play lists, and the play list would be formatted as such.

The RTSMS 106 then builds a reservation for that viewer 116 or 118 for that customized play list and temporarily reserves the resources identified in the reservation process for use by the viewer 116 or 118. The RTSMS 106 transmits the reservation data to the selected NRP 108 and transmits the customized play list to the viewer 116 or 118.

The reservation data uniquely identifies the viewer 116 or 118 and the customized play list. In one embodiment, a separate URL identifies each name on a play list for a presentation, and the reservation has a unique reservation number that is located in each URL. The URLs are transmitted to the viewer 116 or 118 using the play list, and the viewer can use the play list to initiate a session with a switch. A reservation is a unique feature that enables the streaming system 102 to reserve system resources, such as switches, processors, or media, either now or in the future, to ensure a quality media experience.

The RTSMS 106 maintains historical, current, and future views of the processing tables that reside in all NRPs in the streaming system 102, including the NRP 108. These tables and the associated data stored by the RTSMS 106 enable the NRPs 108 to determine a switch, such as the MMS 110, that can provide the requested media to a viewer 116 and 118.

The RTSMS 106 collects state model data from all NRPs and switches in the streaming system 102, including the NRP 108 and the MMS 110. The state model data identifies a viewer using a reservation, identifies the switch from which it is streamed, identifies the media that is streamed, the duration the media is streamed, and other state changes in the streaming, such as whether a stream is paused, canceled, forwarded, or reversed. If a presentation is streamed, the state model data identifies the presentation and the media in the presentation. The state model data includes stream state changes, viewing session state changes, device mode changes from the NRP 108 and the MMS 110, error and alarm conditions for any MMS, NRP, SMS, ESRP, or other communication device in the streaming system 102. A state model is kept for each NRP and each MMS as described more fully below.

The RTSMS 106 also collects logs and billing data from the ESRP 104, the NRP 108, and the MMS 110. The billing data will include the order data and the reservation data and may include state model data described above. The logs are a record of the events that have occurred and are viewable and auditable. Logs are generated by many processes, such as one or more media servers on one or more stream casters, one or more NRPs, one or more MMSs, one or more reservation servers, and one or more ESRPs.

The RTSMS 106 processes the logs, the billing data, and the state model data and creates a message sequence detail record (MSDR). The MSDR is a collated view of log and state model data. The RTSMS 106 creates an MSDR for every reservation by obtaining information from the reservation order log, the MMS 110 logs, and the NRP 108. This is accomplished using the unique reservation identification that is contained in every log and billing data file. The MSDR represents the billable event record that will be used for revenue settlement purposes.

The RTSMS 106 processes the MSDRs and creates bills in accordance with the media rules and orders identified in the presentations. Logs, state model data, and billing data for a single viewer 116 or 118 may come from more than one NRP, more than one MMS, and more than one ESRP.

The RTSMS 106 is able to collate all of this data into a single MSDR for a reservation identifying the viewer 116 or 118 using the reservation data and the state model data. This process of being able to service media requests from more than one switch or more than one stream caster on a switch is unique to this streaming system 102. Prior systems could not use multiple switches to provide media to a single viewer and clearly identify billing data because the prior systems cannot track and collate billing information from multiple switches. Prior systems service a media request from a single media server in these instances.

The RTSMS 106 can be configured to dynamically generate advertising. In one embodiment, the RTSMS 106 is configured to use statistical information to dynamically generate an advertisement for a presentation. For example, if it is known that a person using the viewer is between the ages of 18-25, the RTSMS 106 may dynamically place a media clip for a first advertisement in the presentation. Whereas if the person using the viewer is between the ages of 26-32, the RTSMS 106 may dynamically place a media clip for a second advertisement in the presentation. The ability to dynamically generate advertisement can result in a different revenue basis for different presentations. For example, in the above examples, revenue of three dollars may be collected for the first media clip, and revenue for four dollars may be collected for the second media clip. The RTSMS 106 can process the dynamic advertisement generation using statistical information and bill or credit entities according to order rules.

Statistical identification is the determination that the viewer is within a geographic area, such as a zip code or an NPA-NXX, that the viewer is within an age group, such as 18-23 years, that the viewer can watch movies of a designated media rating, such as PG, PG-13, or Y-14, that the viewer is male or female, the viewer's marital status, and other relevant personal data. If the presentation requires statistical identification of the viewer, the RTSMS 106 looks to any previously collected information about the viewer. If no information exists, the RTSMS 106 instructs the reservation server 114 to collect the required information. If the viewer does not supply the required information, the RTSMS 106 could reject the viewing request.

The RTSMS 106 provides reporting capabilities. The reports include near real-time reports of what media is streamed and the associated statistical information, including demographics on the entire network. The RTSMS 106 provides network management capabilities, including operational measurement collection, threshold alarming, and trend analysis.

The RTSMS 106 has a human machine interface (HMI) that enables a network operator to access the RTSMS or another communication device in the streaming system 106. The network operator can use the HMI to load new software to, for example, the MMS 110, to upgrade configurations, or to provide other maintenance, such as to execute functions specifying capacity to be used, to identify when switch components will be taken out of service for maintenance, to create new products or services for use by the a media owner, and to issue test presentations to specific media servers on an MMS.

The RTSMS 106 receives from the MMS 110 and any other switches streaming information blocks (SIBs) comprising signaling, event, and billing information associated with each streaming session. The RTSMS 106 combines the information in the SIB with fixed attributes, such as a viewer identification associated with a reservation number, a viewer profile, a viewer location, a media category being viewed, and other data to create a media signal detail record (MSDR). The RTSMS 106 uses the reservation number in the SIBs as the key to determining all SIBs for a presentation or a streaming event. The RTSMS 106 uses to reservation number to collate all SIBs for that presentation or streaming event into the MSDR. The MSDR therefore represents all data needed for billing records and reports for a presentation or other streaming event. The MSDR creates an auditable event record that is used for operational measurements and billing. The RTSMS 106 then can use the MSDR with rules identified in an order to determine bills and credits to be appropriated to various entities.

The RTSMS 106 receives from the NRP 108 and all other routing processors an NRP log comprising reservation routing requests and their granting or refusal, including identification of switches streaming media and the associated session data. The RTSMS 106 stores the NRP logs and retrieves the NRP logs if needed for auditing purposes.

An RTSMS 106 may be a local or regional RTSMS. The RTSMS 106 of FIG. 1 is depicted as a local RTSMS. One or more RTSMS devices may exist in the streaming system 102. One RTSMS 106 is depicted in FIG. 1 for clarity.

The NRP 108 receives a request from a viewer 116 and 118 and processes the request. The request contains the identification of NRP to which it is sent, and the reservation identification generated by the RTSMS 106. For example, the NRP 108 reservation may be an NRP host name or an NRP IP address, and the reservation identification may be a reservation number.

The NRP 108 processes the request and compiles a list of switches that may be able to provide the requested media to the requesting viewer 116 or 118. The NRP 108 identifies in order, and attempts to select, a switch based on network distribution rules. For example, the network supplier can choose to route on the best possible quality of service that can provided to the viewer 116 or 118, to route on geographic factors, the time of day, the day of the week, the day of the year, or the access provider, or to route on overall network conditions.

The NRP 108 communicates with the switches starting with the best-identified switches to determine which switch, if any, can provide the requested media. The NRP 108 transmits to the viewer 116 or 118 an IP address of the switch that can provide the requested media.

In one embodiment, a request is sent from the viewer 116 or 118 to the NRP 108 for each media clip on the play list. Thus, the NRP 108 must determine a switch that can stream the particular media clip of the play list to the viewer 116 or 118 separately for each media clip on the play list. Each time the NRP 108 determines the switch that can provide the media clip, the NRP transmits an IP address of the switch or a communication device, such as a stream caster on the switch, to the viewer 116 or 118.

For example, if a play list identifies two media clips, the viewer 116 or 118 transmits a media locator request to the NRP 108 for the first media clip. The NRP 108 determines a switch that can provide the first media clip and transmits an IP address of that switch to the viewer 116 or 118. After the viewer 116 or 118 receives the first media clip in a session with that switch, the viewer could send another media locator request to the NRP 108 for the second media clip. The NRP 108 determines a switch that can provide the second media clip and transmits an IP address of that switch to the viewer 116 or 118. The viewer then receives the second media clip in a session with that switch.

The switch that streams the first media clip may be the same as or different from the switch that streams the second media clip. Also, multiple devices on one switch, such as two different stream casters on a switch, each may stream one of the media clips or one device on the switch may stream both media clips.

The NRP 108 also can be configured to determine a switch that can provide all media clips on a play list. In this embodiment, a single determination is completed by the NRP 108 in which the NRP locates a single switch that can stream all media clips on the play list to the viewer 116 or 118.

The NRP 108 receives and processes signaling from each MMS and each other switch before, during, and after media is streamed. If a switch fails during a media streaming, the switch notifies the NRP 108, and the NRP determines a different, second switch that can provide the requested media. The NRP 108 then directs the failing switch to route the streaming session to the second switch.

The NRP 108 initiates a state model for each viewer and each streamed media. The state model comprises a view of an entire media streaming event to a viewer 116 or 118, including which switch or switches streamed media to the viewer, the time each media request is sent to each switch, any alarm or error events for a switch such as alarms or events that may require another switch to provide the requested media, and transfers or re-connections to another switch to provide the requested media. The state model includes an identification of devices within the switch that provide the requested media to the viewer 116 or 118, such as which stream caster or stream casters within an MMS 110 stream media to the viewer, as described more fully below.

The state model in the NRP 108 includes switch identification and the major states of a session or a connection, sometimes referred to as persistent states. Major states may include the reservation acceptance, an initiation of a session or connection, a termination of a session or connection, and other persistent states. The state changes may be receive when setup or teardown messages are received by the MMS 1100 and at other states. Each state change is identified with the reservation identification.

The NRP 108 transmits an NRP log to the RTSMS 106 when the media for a presentation has been streamed to a viewer 116 or 118, if an error occurs during a streaming session, and periodically during a streaming session. The period during the streaming session is configurable. In one embodiment, the period is every five minutes. Another period or default mechanism may be used, such as the occurrence of an event.

The NRP 108 may use the domain name system (DNS) protocol to receive the media locator request from the viewer 116 and 118 and to return an IP address of the stream caster in the MMS to which the viewer will connect for a session. Other protocols, such as SIP or H.323, may be used.

One or more NRP devices may exist in the streaming system 102. One NRP is depicted in FIG. 1 for clarity.

The MMS 110 streams media to a viewer 116 or 118. The MMS 110 has other communication devices, such as one or more stream casters and one or more media servers, that provide requested media to a viewer 116 or 118. The MMS 110 monitors all communication devices, such as one or more stream casters and one or more media servers, within the MMS so that at any time the MMS can determine if it can provide a requested media.

The MMS 110 may have a stream routing processor (SRP) or another type of processor or monitor that processes requests for media using the current state of the switch, such as available bandwidth, bandwidth necessary to provide a requested media, hardware and software version compatibility, disk space capacity, and the current operating mode of the MMS. The MMS 110 monitors the delivery of each media stream and the status of switch systems. The MMS 110 detects imminent failure of communication devices in the MMS, such as failure of a stream caster's media server. The MMS 110 can transmit this data to the NRP 108.

If a stream caster, a media server on the stream caster, or another communication device in the MMS 110 fails, the MMS can transparently transfer all streams in-progress to another stream caster or to another media server on the stream caster, if one is available. The transfer and the continued streaming of the media are not recognizable by the viewer 116 and 118.

If a communication device on the MMS 110 fails and another is not available on that MMS, the MMS notifies the NRP 108 and the RTSMS 106. In response, the MMS 110 will receive and process from the NRP 108 a message instructing the MMS to route the stream to another MMS. The MMS 110 then will route the stream to the identified MMS.

The MMS 110 has a state model in which the MMS stores information and state changes for a viewing session of a presentation. The MMS 110 stores and reports each state change at the appropriate level. For example, the state model stores information and state changes for the initiation of a session, the termination of a session, and all viewing events. Viewing events are events triggered by a viewer that affect the media streaming of the presentation. Viewing events may be, for example, a pause, a stop, a forward, a cancel, or a rewind.

If the MMS 110 transfers a stream to a different stream caster or a different media server, that event is noted in the state model, and the state model stores the information and state changes for the new stream caster or media server. If the MMS 110 transfers a stream to a different MMS, that event is noted in the state model.

The MMS 110 processes signaling from the NRP 108 and returns signaling to the NRP 108. The MMS 110 receives signaling messages inquiring if the MMS can stream media to a viewer 116 or 118. The MMS 110 processes that inquiry, determines if it has the resources, such as a stream caster type, network bandwidth, disk space, and a media server, to stream the media, and responds with a message to the NRP 108 accepting or denying the inquiry.

The MMS 110 receives reservation data from the NRP 108 for a media clip in a presentation. If the MMS 110 receives the reservation number for the presentation from the viewer 116 or 118 within a configurable period of time, the MMS 110 will stream the media to the viewer. If the viewer 116 or 118 does not transmit the valid reservation number to the MMS 110 for that presentation, or if the viewer transmits the correct reservation number but not within the configurable period of time, the MMS will not stream the media to the viewer. In that instance, the MMS 110 will reject the request from the viewer 116 or 118, and a session will not be initiated, but the rejection is transmitted to the RTSMS 106.

The MMS 110 transmits to the RTSMS 106 stream information blocks (SIBs) for each stream session event and for each viewing session event. The SIB comprises information associated with the streaming session from the MMS 110 to the viewer 116 or 118, including the reservation number, an identification of the MMS or other switch, the stream caster and media server used, the media streamed, the presentation identification, the packet data path for each session, the equipment used for the streaming, and/or viewing events, such as a pause or rewind. One or more of the previous items may be used or not used in the SIB. If more than one stream caster or media server on one or more stream casters is used, that information also is specified.

An SIB is transmitted when a viewing session is initiated, when a viewing session is terminated, when new media is presented, during a streaming session at configurable periods, and when a viewing event occurs, such as a pause, stop, rewind, forward, or error. In one embodiment, the period is configured at five minutes. Other periods, different periods, or defaults, such as an event, can be used.

One or more MMS devices may exist in the streaming system 102. One MMS is depicted in FIG. 1 for clarity.

The packet networks 112 and 120 are any packet network capable of transmitting data, such as signaling or media streaming, to or from a communication device in the streaming system 102, such as to or from the ESRP 104, the RTSMS 106, the NRP 108, the MMS 110, the reservation server 114, and/or the viewers 116 and 118. The packet networks 112 and 120 may be the Internet, an intranet, a virtual private network, a cable system, a frame relay network, an ATM network, a satellite network, and/or other packet based networking solutions. In one embodiment, the packet network 112 is a private network accessible by the ESRP 104, the RTSMS 106, the NRP 108, the MMS 110, and an authorized reservation server 114. In one embodiment, the packet network 120 is a public network.

The reservation server 114 is any server capable of communicating with a viewer 116 or 118. The reservation server 114 manages communications between the viewer 116 and 118 and the RTSMS 106. For example, the reservation server 114 may transmit viewer media selections to the RTSMS 106 and may transmit reservation data originating from the RTSMS to the viewer 116 or 118. The reservation server 114 may be a web-based server, a set top server, or another type of server. The viewer 116 or 118 may use the hypertext mark-up language (HTML) IP protocol via IP sessions using a web browser that can be serviced by a web-based server. The viewer 116 or 118 also may use broadband protocols via a broadband connection using a set top box appliance communicating with a set top server. A set top server can process various protocols, including session initiation protocol (SIP), which is an International Telecommunications Union (ITU) H.323 series protocol. The reservation server 114 of FIG. 1 is authorized to transmit messages to the RTSMS 106.

The viewers 116 and 118 are any communication device capable of transmitting and/or receiving signaling or media. The viewers 116 and 118 may be broadband based viewers or in-band based viewers. For example, the viewers 116 and 118 may have a browser configured to communicate using a web based protocol such as hypertext transfer protocol (HTTP). Also, the viewers 1165 and 118 may have a media player configured to play media that is streamed to the viewers. In addition, the viewers 116 and 118 may have a set top box or another digital appliance configured to play media streamed from a cable television provider, a digital satellite provider, or another type of provider.

In some embodiments, the NRP 108 requests the MMS 110 to provide a media clip. In this embodiment, if the MMS 110 can provide the requested media clip, the MMS responds to the NRP 108 that it can provide the requested media clip. The NRP 108 transmits a message to the viewer identifying the MMS 110 as providing the media clip. The viewer 116 initiates a session or a connection to the MMS 110, and the MMS provides the requested media clip.

In other embodiments, the NRP 108 requests the MMS 110 to provide multiple media clips. In this embodiment, if the MMS 110 can provide the requested media clips, the MMS responds to the NRP 108 that it can provide the requested media clips. The NRP 108 transmits a message to the viewer identifying the MMS 110 as providing the media clips. The viewer 116 initiates a session or a connection to the MMS 110, and the MMS provides all of the requested media clips without further action from the NRP 108. In this embodiment, in one instance, the viewer 116 or 118 initiates a single session or connection with a single setup message, and the MMS 110 streams all requested media clips before the session or connection is terminated. In another instance, the viewer 116 or 118 transmits a separate setup message and teardown message for each media clip, and the MMS 110 stops streaming media after the last requested media clip is streamed.

In other embodiments, the NRP 108 requests the MMS 110 to provide multiple media clips. In this embodiment, if the MMS 110 can provide the requested media clips, the MMS responds to the NRP 108 that it can provide the requested media clips. The NRP 108 transmits a message to the viewer identifying the MMS 110 as providing the media clips. The viewer 116 initiates a session or a connection to the MMS 110, and the MMS provides all of the requested media clips. However, after each media clip is streamed, the viewer 116 or 118 communicates with the NRP 108 to receive authorization to initiate a session with the MMS 110. The NRP 108 communicates with the MMS 110 to confirm that the MMS 110 can provide the next media clip. The MMS 110 acknowledges to the NRP 108 that it can provide the next media clip, and the NRP acknowledges to the viewer 116 that the MMS 110 can provide the next media clip. The viewer 116 then transmits another setup message to the MMS 110 to obtain the next media clip.

In some embodiments, the NRP 108 requests the MMS 110 to provide a presentation. In this embodiment, if the MMS 110 can provide the requested presentation, the MMS responds to the NRP 108 that it can provide the requested presentation. The NRP 108 transmits a message to the viewer identifying the MMS 110 as providing the presentation. The viewer 116 initiates a session or a connection to the MMS 110, and the MMS provides the requested presentation. In some instances in this embodiment, the viewer 116 transmits a setup message for each media identified in the presentation play list, receives the media, and tears down the session or connection for that media. The viewer 116 then immediately transmits another setup message to the MMS 110 to get the next media on the play list. The viewer 116 receives the media and tears down the session or connection. This process continues until the viewer 116 has received all media on the play list. In other instances in this embodiment, the viewer 116 transmits a setup message to the MMS 110, receives the media, transmits a teardown message to the MMS, and communicates with the NRP 108 prior to transmitting another setup message to the MMS to confirm that the MMS will provide the next media clip on the play list.

The examples for all Figures below reference publication by an owner, a distribution by the ESRP 104, a request and selection by a viewer 116 or 118 of media, the reservation made by the RTSMS 106, the communication to between the RTSMS and the NRP 108, the subsequent request from the NRP to the MMS 110, the acknowledgement or denial or service by the MMS, the communication from the NRP to the viewer denying or accepting the presentation streaming, and the subsequent session or connection from the viewer to the MMS. In the examples, reference to these actions identifies the embodiment as distributing, requesting, or providing the media in accordance with either the presentation embodiment or the media clip embodiment described above. However, this discussion uses the presentation embodiment and the media clip embodiment for clarity and conciseness. It should be appreciated that any of the above stated embodiments, or any combinations thereof, may be used.

The streaming system 102 of FIG. 1 operates as follows. In a first example, a media owner generates a presentation with an order that is placed on the ESRP 104. The presentation has multiple media items, including a media clip for a movie and an advertisement. The presentation includes a time restriction that it is not to be played between the hours of 7:00 p.m. and 9:00 p.m. Pacific Time. The presentation further includes a geographic restriction requiring the presentation to be placed on a switch in the western region of the United States, including (California.

The order for the presentation includes billing information, such as a credit that is to be provided to the media owner of 80% of the revenue generated from the presentation, and the advertising owner is to be credited for the remaining 20%. The media owner publishes the presentation with the respective order to the ESRP 104.

The ESRP 104 processes the presentation with its respective media rules and order. The ESRP 104 distributes the presentation to multiple switches in the western United States, including California. The ESRP 104 also transmits to the RTSMS 106 the publication data, including an identification of the media clips in the presentation, the media rules, and the order.

A viewer 116 selects an option to obtain one or more presentations which for example, contain movie media clips. In this example, the option is a link on the reservation server 114. When the link is selected, the reservation server 114 calls the RTSMS 106.

The RTSMS 106 is notified that the viewer 116 requested access to the presentation. The RTSMS 106 determines that the presentation is active within the network and the order may request addition viewer billing information, such as a credit card for a pay per view event or a subscription password to be supplied for billing authorization. The RTSMS 106 determines if the presentation contains media rules that require a statistical identification of the viewer. If required by the media rules, the RTSMS 106 collects the statistical information.

The RTSMS 106 builds a reservation having the identification of the viewer, the identification of the NRP 108. In this example, the NRP identification is the host name of the NRP 108. The reservation also includes the presentation identification, including the customized play list of the presentation. The customized play list includes media selected based upon the statistical identification data, time of day, day of week, and personal viewing preferences. The RTSMS 106 transmits the reservation data to the NRP 108. In addition, the RTSMS 106 transmits to the viewer 116 the play list with each entry on the play list having the host name of the NRP, the reservation number, and the presentation identification.

The viewer 116 transmits a media locator request to the NRP 108. The media locator request comprises the at least one name on the play list, the NRP host name, and the reservation number. The NRP 108 uses the received reservation number to obtain the presentation identification plus additional data about the reservation. The NRP 108 processes the media locator request and the reservation data to determine if an MMS within the streaming system 102 can service the request. The NRP 108 compiles a list of MMSs that have the presentation and that can provide the presentation according to the media rules. In this example, the NRP 108 determines, based on load balancing factors and network distribution rules, that the MMS 110 is the best selection to provide the presentation.

The NRP 108 communicates with the MMS 110 to determine if the MMS can provide the presentation. The MMS 110 responds that it can provide the presentation to the viewer 116. In this example, the MMS 110 has a stream caster that can stream the presentation to the viewer 116.

The NRP 108 transmits to the viewer 116 an IP address of the MMS 110. In addition, the NRP 108 transmits the reservation data to the MMS 110. Also, the NRP 108 saves information in a state model identifying the reservation number, the presentation identification, that the MMS 110 will stream the presentation to the viewer 116, and the time of the MMS acceptance of the streaming request.

The viewer 116 receives an IP address and initiates a session with the MMS 110. The MMS 110 streams the presentation to the viewer 116, including the movie media clip and the advertisement. The MMS 110 retains information in a state model identifying the reservation number, the presentation identification, the start and stop times of each media on the play list, and any viewing events, such as a pause, a forward, a reverse, or other events.

When each media on the play list has been streamed to the viewer 116, the viewer initiates an end to the session. The MMS 110 stores information in the state model identifying the end of the session. The MMS 110 transmits its logs, SIB information, and state model information to the RTSMS 106.

The MMS 110 notifies the NRP 108 that the presentation streaming is complete. The NRP 108 stores information in the state model 108 identifying that the presentation streaming is complete and transmits the state model data to the RTSMS 106.

The RTSMS 106 processes the logs, the SIB information, and any additional data that originated from state models from both the NRP 108 and the MMS 110. The RTSMS 106 collates the data using the reservation number to produce the MSDR data identifying billable events, including the presentation that was streamed to the viewer 116 and the amount of media and time streamed to the viewer. The RTSMS 106 applies the order rules to the MSDRs and produces as an example a financial settlement. In this example, the RTSMS 106 produces a report identifying a credit of 80% of the revenue generated by the presentation for the media owner and a credit of 20% of the revenue generated by the presentation to the advertisement owner.

In another example, the viewer 118 requests media and receives a reservation from the RTSMS 106 to view a presentation. The presentation has three media clips. In addition, the NRP 108 has received the reservation data from the RTSMS 106. In this example, the MMS 110 has two stream casters.

The viewer 118 transmits a request containing the reservation to the NRP 108. The NRP 108 processes the media locator request with the reservation data received from the RTSMS 106 to compile a list of switches that can provide the requested presentation. The NRP 108 communicates with the MMS 110 to determine if the MMS can provide the presentation to the viewer 118. The MMS 110 responds to the NRP 108 that it has a stream caster that can stream the presentation to the viewer 118. The NRP 108 transmits an IP address of the first stream caster on the MMS 110 to the viewer 118.

The viewer 118 initiates a session with the first stream caster on the MMS at an IP address provided by the NRP 108. The MMS 110 stores all information regarding the streaming and the state model. In addition, the MMS 110 notifies the NRP 108 that the streaming session has been initiated.

The NRP 108 stores information in a state model identifying the MMS 110 as providing the presentation. This information is transmitted in an NRP log to the RTSMS 106 at a specified configurable time. In this example, the NRP 108 transmits the NRP log to the RTSMS 106 every five minutes. In other examples, the NRP 108 can be configured to transmit the NRP log to the RTSMS when a session is initiated between a viewer and a particular switch and when that session is terminated. In addition, in other examples the NRP 108 can be configured to transmit the NRP log at other configurable times or different configurable times.

When the session is initiated between the viewer 118 and the MMS 110, the MMS transmits an SIB to the RTSMS 106. In addition while the media is streamed from the MMS 110 to the viewer 118, an SIB is transmitted to the RTSMS 106 at a configurable time. In this example, the configurable time is every five minutes. In other examples, the time may be configured at other periods of duration or different periods of duration. In addition, in this example, the MMS 110 transmits an SIB to the RTSMS 106 when viewing events occur, such as a stop, a pause, a forward, or a rewind. Also, when the presentation streaming is complete and the session is terminated, the MMS 110 transmits an SIB to the RTSMS 106.

When the session is complete and terminated, the MMS 110 notifies the NRP 108. The NRP 108 transmits a final NRP log to the RTSMS 106.

In this example, the RTSMS 106 collates all of the SIBs into an MSDR. The MSDR then can be used to provide billing records to billing entities according to billing rules, such as those that may be in an order associated with the presentation. In other examples, the RTSMS 106 may use the NRP logs in conjunction with the SIBs to create the MSDR.

In another example, the viewer 116 has received a reservation from the RTSMS 106. In addition, the NRP 108 has received the reservation data from the RTSMS 106. The viewer 116 transmits a media locator request to the NRP 108, and the NRP 108 processes the media locator request with the reservation data received from the RTSMS 106. The NRP 108 compiles a list of switches, including the MMS 110, that can provide the presentation identified in the reservation. The NRP 108 communicates in turn with the MMS 110 to determine if the MMS can provide the presentation. The MMS replies to the NRP 108 specifying that it can provide the presentation. The NRP 108 transmits an IP address of the MMS 110 to the viewer 116.

The viewer 116 initiates a session with the MMS 110. The MMS 110 streams the presentation to the viewer 116 as requested.

While the MMS 110 is streaming the presentation to the viewer 116, an error occurs, and the MMS is not able to continue streaming the presentation to the viewer. The MMS 110 notifies the NRP 108 that it cannot continue streaming the presentation to the viewer 116.

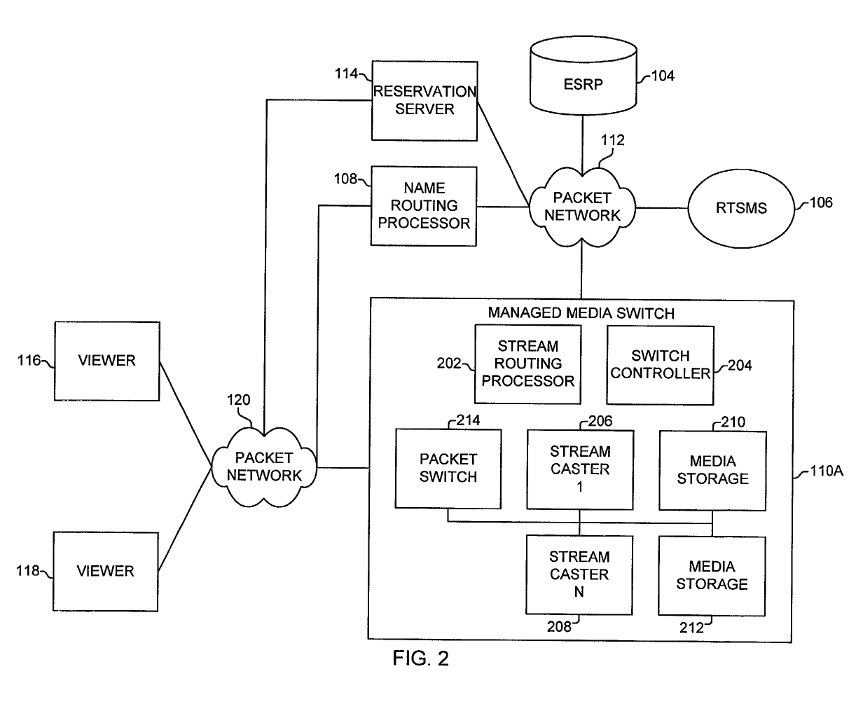

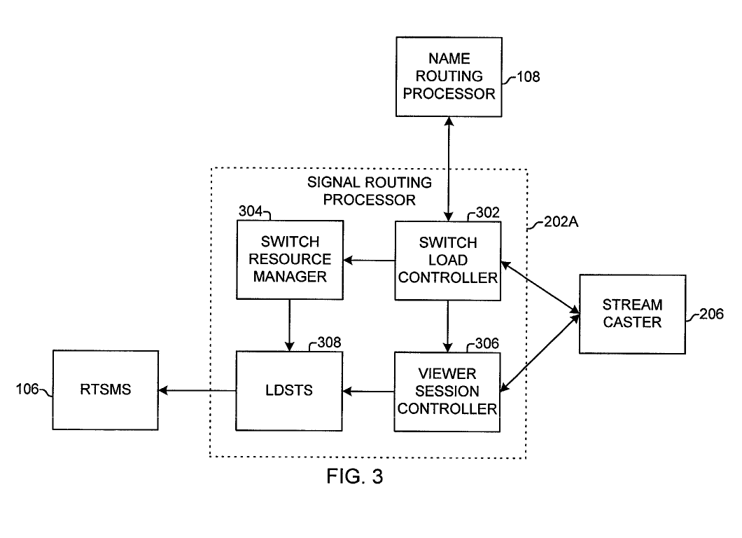

The NRP 108 determines that the session for the presentation must be re-routed and communicates with a second MMS identified on the list of switches capable of providing the presentation (see FIG. 2 or FIG. 3). The second MMS notifies the NRP 108 that it can provide the presentation. The NRP 108 notifies the MMS 110 to route the session to the second MMS.

The session is routed to the second MMS. The second MMS provides the rest of the presentation to the viewer 116. When the presentation is provided, the session is terminated by the viewer 116. The second MMS notifies the NRP 108 that the streaming for the presentation is complete and the session is terminated.

In this example, the MMS 110 transmitted SIBs to the RTSMS 106 when the session was initiated, during the configurable periods of time while the presentation was streaming, during any viewing events, and when the stream caster failed and the session was routed to the second MMS. Likewise, the second MMS transmitted SIBs to the RTSMS 106 when the session was routed to the second MMS and the second MMS started streaming the media for the presentation, during the configurable period of time while the presentation was streaming, when any viewing events occurred, and when the session was terminated. Each of the SIBs identify the reservation number for the presentation. In addition, the NRP 108 transmits NRP logs to the RTSMS 106 identifying both the MMS 110 and the second MMS when the respective MMSs provided the media streaming for the presentation.

The RTSMS 106 receives the SIBs from the MMS 110 and the second MMS. The RTSMS 106 collates the SIBs to create an MSDR using the reservation number identified in each SIB. The MSDR then can be used for settlement purposes.

In another example, the viewer 118 requests access to media. The RTSMS 106 returns a reservation to the viewer 11 8. The reservation includes a play list that has two media clips in addition to the reservation identification and the NRP identification. In this example, the media clips are identified by URLs, and the reservation identification is a reservation number attached to the URL. Also, the NRP identification is this example is a host name for the NRP 108. The RTSMS 106 also transmits the reservation data to the NRP 108.

The viewer 118 transmits a request to the NRP 108. In this example, the request is a media locator request. The media locator request identifies the play list reservation identification. The NRP 108 processes the media locator request and the reservation data received from the RTSMS 106. The NRP 108 compiles a list of all possible switches that can handle the presentation identified by the play list.

The NRP 108 communicates with the MMS 110 to determine if the MMS can provide the presentation. The MMS 110 transmits a message back to the NRP 108 identifying that it can provide the presentation. The NRP 108 transmits an IP address of the MMS 110 to the viewer 118.

The viewer 118 initiates a session with the MMS 110. The MMS 110 streams the media for the first media clip identified on the play list to the viewer 118.

In this example, when the viewer 118 has received all of the media for the first media clip, the viewer terminates the streaming session by initiating a tear down message. This may occur, for example, when the next media clip on the play list requires a different media server type.

The viewer 118 determines that there is a second media clip of a different media server type on the play list for the presentation. The viewer 118 contacts the NRP 108 to determine if a switch is able to provide the second media clip for the presentation.

The NRP 108 communicates with the MMS 110 to determine if the MMS can provide the second media clip on the play list for the presentation. The MMS 110 communicates back to the NRP 108 with a message stating that the MMS 110 cannot provide the second media clip on the play list for the presentation because the MMS does not have the required media server.

The NRP 108 receives the message from the first MMS 110. The NRP 108 communicates with a second MMS (see FIGS. 2 and 3) to determine if the second MMS can provide the second media clip on the play list for the presentation. The second MMS communicates a message to the NRP 108 that it can provide the second media clip on the play list for the presentation. The NRP 108 transmits a message to the viewer 118 identifying an IP address of the second MMS.

The viewer 118 initiates a session with the second MMS at the identified IP address. The second MMS streams the second media clip in the play list for the presentation to the viewer 118. When the streaming for the second media clip is complete, the viewer 118 terminates the session. The second MMS notifies the NRP 108 that the streaming for the second media clip is complete, and that the session is terminated.

The first MMS 110 and the second MMS transmit SIBs to the RTSMS 106 at the initiation of each session, at the termination of each session, upon viewing events, and at configurable periods of time. In addition, the NRP 108 transmits NRP logs to RTSMS 106. The SIBs and the NRP logs identify the reservation number for the presentation.

The RTSMS 106 collates the SIBs from each of the first MMS 110 and the second MMS to create an MSDR. The MSDR can be used for billing records and other settlement purposes.

FIG. 2 depicts an exemplary embodiments of an MMS of the present invention. The MMS 110A of FIG. 1 comprises a stream routing processor (SRP) 202, a switch controller (SC) 204, one or more streaming devices, including a first stream caster 206 and an Nth stream caster 208, one or more media storage devices, such as a first media storage 210 and an Nth media storage 212, and a packet switch. Although more than one stream caster and more than one media storage are shown in the embodiment of FIG. 2, one stream caster and one media storage may be used.

The SRP 202 monitors the status of the current state of the switch, such as the available bandwidth, the bandwidth necessary to provide a requested presentation, hardware and software version compatibility, the disk space capacity, and the current operating mode of the MMS 110A. In addition, the SRP 202 monitors the delivery of each media stream and detects imminent failure of communication devices in the MMS 110A, such as failure of a media server in a stream caster 206 or 208.

The SRP 202 determines if the MMS 110A can provide a requested presentation based on signaling from the NRP 108 identifying the request, signaling from one or more stream casters 206 and 208, and the current state of the MMS 110A as identified above. If the SRP 202 determines that a stream caster 206 or 208 can provide the requested presentation, the SRP notifies the NRP 108 which one of its stream casters can handle the request.

The SRP 202 maintains a state model for each session and each attempted session. The SRP 202 records each state change in the state model. The state model data identifies a viewer using a reservation, identifies the media that is streamed, the duration the media is streamed, viewing session state changes, viewing events, device mode changes, error and alarm conditions, and other state changes in the streaming. The SRP 202 stores and reports each state change at the appropriate level. For example, the state model stores information and state changes for the initiation of a session, the termination of a session, and all viewing events. Viewing events are events triggered by a viewer that affect the media streaming. Viewing events may be, for example, a pause, a stop, a forward, or a rewind. If the SRP 202 transfers a stream to a different stream caster or a different media server, that event is noted in the state model, and the state model stores the information and state changes for the new stream caster or media server. If the SRP 202 transfers a stream to a different MMS, that event is noted in the state model.

The SRP 202 receives and processes signaling from the NRP 108 and other communication devices, and transmits signaling to the NRP and other communication devices. Typically, the signaling messages from the NRP 108 request the MMS 110A to provide a presentation or request the status of the MMS and its devices. The SRP 202 responds accordingly. In addition, the SRP 202 transmits state model data, including state change data, alarm data, and other error condition data to the NRP 108.

The SRP 202 transmits signaling to one or more stream casters 206 or 208 for media processing and receives and processes signaling from one or more of the stream casters. Typically, the signaling messages transmitted to the stream casters 206 or 208 include a request to determine if the stream caster can provide a requested presentation, a request for status of the devices on the stream caster, or a request for state model data, including state change data. The SRP 202 also transmits reservation data, including a reservation identification and a presentation play list, to a stream caster 206 or 208 that has accepted a requested presentation. The SRP 202 receives from the stream casters and processes signaling messages indicating whether or not the transmitting stream caster can provide the requested presentation, the status of the stream caster or its devices, state model data including state change data, alarm conditions such as a media server failure, and other error condition.

The SRP can obtain signaling and data from, and transmit signaling and data to, a communication device, such as a digital set top box or a personal data assistant (PDA) device. Such signaling and data may be transferred, for example, as a session initiation protocol (SIP) message in queries or responses or as other SIP messages.

The switch controller 204 monitors and records the state of all resources in the MMS 110A, including hardware resources, such as processor capacity and bandwidth capacity, and software resources. The state information can include whether the hardware resource is working, whether the hardware is working but producing errors, whether alarm thresholds have been exceeded in capacity usage, the amount of capacity usage, imminent failure of media server software, etc._The switch controller 204 may use network management signaling protocols, such as simple network management protocol (SNMP), common management information protocol (CMIP), and/or private human machine interface (HMI) protocols to maintain the state of all the resources.

The switch controller 204 monitors each physical hardware component within the MMS 110A and report service impacting events and capacity impacting events to the alarm/event handling processes. Service impacting events are events that decrease the availability of resources to service media requests. For example, if a stream caster has a critical failure on the data communications card, the capacity of that stream caster to service media will be impacted. The alarm/event handling system determines if the event impacts ongoing streaming services or the capacity of the MMS 110A to process new media requests. The switch controller 204 monitors all events that relate to data communications, processor capacity, disk storage capacity, memory use or availability, and processes or devices critical to the delivery of streaming media, such as a streaming media server.

The switch controller 204 filters the state data and notifies the SRP 202 and the RTSMS 106 of any events that effect the current capacity of the MMS 110A, require the not to exceed capacity items to be altered, or if the event impacts ongoing streaming services or the capacity. The switch controller 214 also monitors and feeds the SRP 202 and RTSMS 106 any information required about non-service generated events. The switch controller 204 also can act as a go between in altering the provisioning of the stream casters 206 and 208.

The stream casters 206 and 208 stream media from the MMS 110A. The stream casters 206 and 208 accept a session or connection setup only from a viewer 116 or 118 having a valid reservation. The stream caster 206 and 208 receive, process, and transmit signaling directly from and to the viewers 116 and 118. This signaling may include setup type signaling, teardown type signaling, viewing event signaling, and streaming status, such as lost packet identifications, received packet information, streaming quality information, and other status information. The stream casters 206 and 208 report to the SRP 202 any state change of an attempted or existing session, including state changes of an existing media stream. The stream casters 206 and 208 are arrayed for delivery of digital streaming video content using one or more media servers, such as Real Player, Quick Time, Windows Media, moving picture experts group (MPEG) protocols, or other protocols.

The media storage 210 and 212 store media for access by the stream casters 206 or 208. The media typically has extremely large storage requirements. For example, digital video storage requirements can range from tens of megabytes to tens of gigabytes or more per video. The control of media caching is linked to the signaling processed via the ESRP. The media caching and storage is directed by the media rules identified in a presentation. Some media storage devices 210 or 212 store deep store media. Deep store media is media that is not retrieved often and may be stored on few switches. The deep store content may be retrieved from the media storage 210 or 212 and transmitted to another MMS for streaming to a viewer 116 or 118. Media storage 210 and 212 may be, for example, disk storage and network attached storage.

The packet switch 214 transmits and receives packets within the MMS 110A and outside of the MMS. The packet switch 214 transmits signaling and media. For example, the packet switch 214 transmits signaling messages between the SRP 202 and the stream caster 206. The signaling messages are transmitted and received as packets.

The packet switch 214 is designed to support disparate packet switching networks, including IP based networks, frame relay networks, ATM networks, and other networks. The packet switch 214 is customized to the network topology that is being used. For example, if the MMS 110A is installed in an ATM network, the packet switch device 214 will be ATM based.

Preferably, the packet switch 214 transmits and receives IP packets. This enables devices to bind to other devices. For example, this enables a media server in the stream caster 206 to bind to a signaling proxy agent or a streaming proxy agent. Thus, if devices in the MMS 110A fail, another device can replace the failing device, and the IP packets merely are redirected to the replacement device. This enables transparent replacement of devices, transparent signaling, and transparent streaming.

The switch controller 204 is directly linked to the packet switch 214 and is set to monitor key operational measures and data indicators for the packet switch. The indicators differ by packet network type but generally relate to packets lost, capacity used, and available bandwidth.

The packet switch 214 supports multicasting of live and simulated live feeds. This provides a broadband subscription based television service to the MMS 110A. In out-of-band signaling embodiments, the out-of-band signaling extends to the packet switch 214 via the switch controller 204. The packet switch 214, with the assistance of the NRP 108, eliminates the need for common load balancing IP equipment. OSI layer five load balancing hardware that is commonly used in current streaming media networks is replaced by the signaling platform of the packet switch 214.

The system FIG. 2 operates as follows. In a first example, the viewer 116 requests media and receives a reservation from the RTSMS 106 via the reservation server 114. The NRP 108 receives the reservation data from the RTSMS 106.

The NRP 108 communicates with the SRP 202 to determine if the MMS 110 can provide the requested media. In this example, the switch controller 204 did not transmit any alarm events to the SRP 202. In addition, the SRP 202 communicates with the stream caster 206 to determine if the stream caster can provide the requested media. The stream caster 206 transmits a message to the SRP 202 that it can provide the requested media, and the SRP transmits a message to the NIP 108 that the MMS 110 can provide the requested media along with an IP address of the selected stream caster 206.

The NRP 108 transmits the reservation data and the IP address of the stream caster 206 to the viewer 116. In addition, the NRP 108 transmits the reservation data, including the reservation identification, to the SRP 202. The SRP 202 transmits the reservation data, including the reservation identification, to the stream caster 206.

The viewer 116 initiates a session with the stream caster 206 at the stream caster's selected IP address via the packet network 120 with a set up message. The stream caster 206 acknowledges the set up to the viewer 116 and a session is initiated.

The stream caster 206 obtains the requested media from the media storage 210 and streams the media to the viewer 116 via the packet network 120. It will be appreciated that the signaling and the media streaming between the viewer and the stream caster occurs via the packet switch 214. In addition, signaling messages transmitted between the devices of the MMS 110, including between the SRP 202, the switch controller 204, the stream caster 206, and the media storage 210 occur via the packet switch 214.

While the media is streamed from the stream caster 206 to the viewer 116, viewing events may occur. Viewing events are viewer controlled streaming selections, such as a pause or a rewind. If a viewer event occurs, the signaling is transmitted from the viewer 116 to the stream caster 206 will pause, rewind, or otherwise control the media streaming accordingly. When the media has been streamed from the stream caster 206 to the viewer 116, the viewer initiates a tear down of the session.

When the streaming is complete, the stream caster 206 notifies the SRP 202. The SRP 202 transmits a signal to the NRP 108 that the media streaming is complete.

While the stream caster 206 is streaming the media to the viewer 116, the stream caster transmits signaling logs to the RTSMS 106. The signaling logs are transmitted at a configurable period of time, such as 5 minutes. In addition, the signaling logs are transmitted each time a viewing event occurs. In addition, the stream caster 206 transmits media server logs at the media server configured periods.

In addition, the SRP 202 transmits a SIB to the RTSMS 106 at configurable periods of time, such as every 5 minutes, at the occurrence of viewing events, and when the media streaming is complete. In addition, the NRP 108 transmits a NRP log to the RTSMS 106 when it is notified from SRP 202 that the media streaming is complete.

In another example, the viewer 116 requests media and receives a reservation from the RTSMS 106 via the reservation server 114. The NRP 108 receives the reservation data from the RTSMS 106.

The NRP 108 communicates with the SRP 202 to determine if the MMS 110 can provide the requested media. In this example, the switch controller 204 did not transmit any alarm events to the SRP 202. In addition, the SRP 202 communicates with the stream caster 206 to determine if the stream caster can provide the requested media. The stream caster 206 transmits a message to the SRP 202 that it can provide the requested media, and the SRP transmits a message to the NRP 108 that the MMS 110 can provide the requested media.

The NRP 108 transmits the reservation data and the IP address of the stream caster 206 to the viewer 116. In addition, the NRP 108 transmits the reservation data, including the reservation identification, to the SRP 202. The SRP 202 transmits the reservation data, including the reservation identification, to the stream caster 206.

In this example, a second viewer 118 attempts to obtain from the viewer 116 the IP address of the stream caster 206 and attempts to initiate a session with the stream caster using the stream caster's IP address. However, the viewer 118 does not have a valid reservation identification, and the reservation identification transmitted by the viewer 118 to the stream caster 206 is not a valid reservation identification.

The stream caster 206 receives the invalid reservation identification, compares the invalid reservation identification with the reservation data received from the SRP 202, determines that the reservation identification is, not valid, and terminates the session with the viewer 118. The stream caster 206 notifies the SRP 202 that it received an invalid reservation identification, and the SRP notifies the NRP 108 that the stream caster 206 received an invalid reservation identification. The stream caster 206 transmits a signaling log to the RTSMS 106. The SRP 202 transmits a SIB to the RTSMS 106, and the NRP 108 transmits a NRP log to the RTSMS.

FIG. 3 depicts an exemplary embodiment of an SRP. The SRP 202A of FIG. 3 comprises a switch load controller (SLC) 302, a switch resource manager 304, a viewer session controller 306, and a log data storage and transport subsystem (LDSTS) 308.

The switch load controller 302 communicates signaling messages to and from the NRP 108 and to and from the stream casters in the MMS 110A. The switch load controller 302 also communicates with the switch resource manager 304 to determine if a stream caster and its associated media player or media players are available to provide the requested media. After the switch load controller 302 communicates with the switch resource manager 304 and receives an identification of the available stream casters, the switch load controller communicates with the one or more identified stream casters.

The switch load controller 302 monitors and stores the events the status of each subsystem, device, and process within the SRP 202A and the MMS 110A as a whole. Thus, the switch load controller 302 manages the MMS 110A at an aggregate level. The switch load controller 302 selects the stream caster 206 that will stream the requested media. The switch load controller 302 selects a different stream caster if a first stream caster's media server fails and another media server on that stream caster is not available, and issues a reroute request to the NRP 108 if a stream caster cannot handle the request, even if that stream caster initially accepted the request to provide the media.

For example, when the switch load controller 302 receives an initial request message (IRM), the switch load controller communicates with the switch resource manager 304 to determine if resources are available to provide the requested media, including one ore more stream casters, one or more media servers, bandwidth, and processing capacity. The switch load controller 302 then communicates with one or more stream casters within the SMS and determines which stream caster can process the request. The switch load controller 302 then transmits the IRM to the stream caster and waits for a reply. If the stream caster replies that it can process the request, the switch load controller 302 transmits an acknowledgment to the NRP 108. The switch load controller 302 updates the switch resource manager 304 with the control data identifying the accepting stream caster and associated required resources needed to provide the request, and transmits the reservation data for the requested and accepted reservation to the stream caster.

The switch load controller 302 has memory that is used to identify the total bandwidth used by the MMS 110, the total number of active media streams, the current not to exceed bandwidth capacity, the current not to exceed media stream capacity, the current processing capacity, and the current not to exceed processing capacity. The memory enables the switch load controller 302 to reject an IRM if accepting the IRM and the associated session would place the MMS 110 above the desired thresholds. If the desired thresholds are not exceeded at the aggregate level, the switch load controller will attempt to locate a stream caster within the MMS 110 to process the IRM.

The switch resource manager 304 monitors all resources within the MMS 110A, including each stream caster and its respective media player or players. The switch resource manager 304 tracks resources currently in use by the individual stream casters and resources used by the MMS 110A as a whole. Memory in the switch resource manager 304 identifies the total bandwidth used by the MMS 110A, the total number of active media streams, current not to exceed bandwidth capacity, current not to exceed media stream capacity, current processor capacity of each stream caster, current not to exceed processor capacity of each stream caster, and other resources and resource status. The switch resource manager 304 also notifies the LDSTS 308 if any of the above thresholds are exceeded.

The viewer session controller 306 maintains the state model and the state changes for the state model for each session. A state model is maintained for each reservation and each attempted reservation, even if the reservation is not accepted.

The viewer session controller 306 receives state model data from the stream caster 206, including stream state changes, viewing events, signaling messages transmitted from the viewer 116 to the stream caster, and other signaling data. The viewer session controller 306 uses the viewer's signaling messages to maintain the state model for the viewer's request for service. The viewer session controller 306 maintains the state model for each attempted and set up session or connection, and transmits the state model data to the NRP 108 via the SLC 302.

In addition, the viewer session controller 306 determines the quality of service that a viewer is receiving by monitoring the number of dropped packets, resent packets, skipping, and rewinds.

The viewer session controller 306 issues a timeout to the stream caster 206 if a viewer has not initiated a session or a connected within a configurable period after a request for reservation has been acknowledged by the stream caster and the switch load controller 206. The viewer session controller 306 also tracks fail over requests from a stream caster 206 to the switch load controller 302.

The viewer session controller 306 creates the SIBs for each session or attempted session for each state model or state model change. The SIB contains all of the information associated with the session, including information gained from signaling messages sent to or from the viewer. The SIB also will include the reservation number, the media viewed, the identification of the MMS 110, the stream caster used, the media server used and the media server type, the media player used, the packet data path, the equipment used to connect the session for the media streaming, and any viewer events.

The LDSTS 308 is a communication mechanism used to send and receive the SIBs and other log data, billing data, and signaling information to and from the RTSMS 106. The LDSTS 308 records and transports the logs and records identifying viewer events to the RTSMS 106. The LDSTS 308 comprises a near real-time push interface (NRTPI) and a historical pull interface (HPI). The NRTPI is a TCP/IP socket connection over which the SIBs are pushed to the RTSMS 106. The HPI retrieves old SIBs that might have been lost by operating errors or data transmission errors.

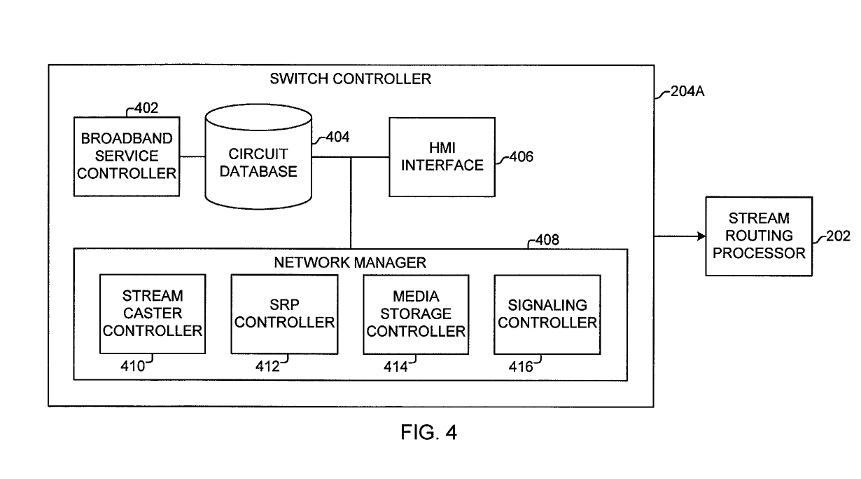

FIG. 4 depicts an exemplary embodiment of a switch controller of the present invention. The switch controller 402 of FIG. 4 comprises a broadband service controller 402, a circuit database 404, a human machine interface 406, and a network manager 408.

The broadband service controller (BSC) 402 monitors the broadband connections to viewers' broadband devices, such as a set top box equipment. The BSC 402 determines if the broadband device is being activated or if a quality of service problem with the connection exists by monitoring the traffic on the broadband device and watching for errors. The BSC 402 monitors and records a state of all virtual circuits that connect to the broadband device. The BSC 402 monitors the status of the broadband device and the transport path from the MMS 110A to the broadband device. The BSC 402 uses polling signaling when the digital device does not have active sessions running on the MMS. The polling determines if the broadband device is at a ready state for receiving media. If the BSC 402 detects that the broadband device is not ready, the BSC can alert the network manager 408 for action.

The circuit database 404 stores the status and identification of the broadband circuits monitored by the BSC 404. Data is stored and retrieved by the BSC 402.

The human machine interface (HMI) 406 enables a network operator to access the switch controller 204A. The network operator can use the HMI 406 to load new software, to upgrade configurations, or provide other maintenance, such as execute functions specifying capacity to be used. The HMI 406 enables a network operator to view current event and operational measure data via a web browser, a graphical based terminal session, and/or the traditional command line HMI. The HMI 406 also supports the configuration and loading of hardware data and broadband circuit data through application programming interfaces (APIs). Three principle APIs are supported. The first are the equipment/circuit inventory identification tables that enable users to determine the exact status and type of physical hardware being used within MMS devices and from the MMS 110A to the digital appliance or broadband device. Also included are service configuration tables that enable a network operator to determine what software and its version is running on each card, including the configurable parameters. Also included are alarm management tables that enable a network operator to view and correct errors in hardware, software, and network routing problems.

The network manager 408 monitors hardware and software processes within the MMS 110A and alerts a network operator in the event of an error or alarm condition. The network monitor of FIG. 4 comprises a stream caster controller 410, an SRP controller 412, a storage controller 414, and a signaling controller 416.

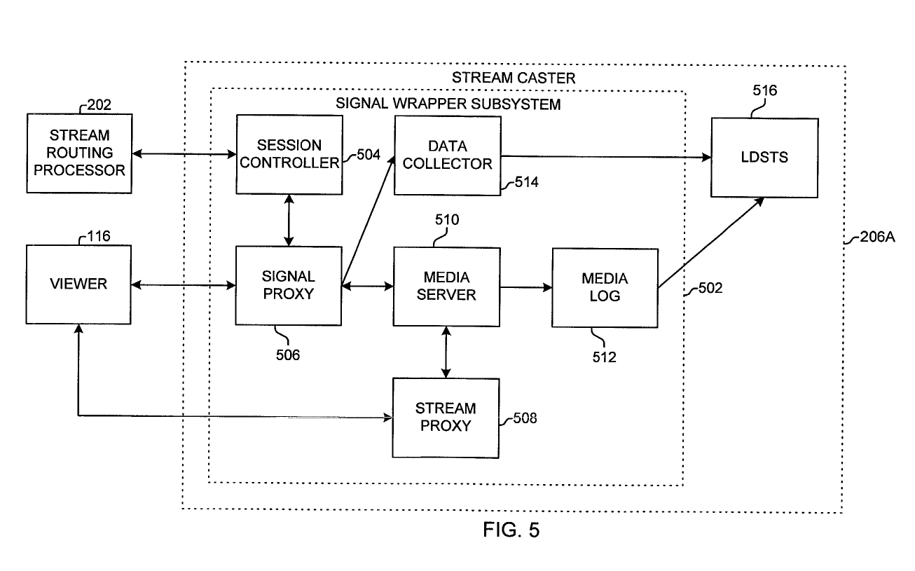

The stream caster controller 410 uses a management information base (MIB) to report if all stream caster hardware components are functioning properly and to collect operational measures on all stream caster components, cpu capacity, packet utilization, packets lost, local disk utilization, and other hardware measurements that relate to streaming service The stream caster controller 410 also monitors stream caster software processes that are key to the delivery of streaming media. For example, if the stream caster signal wrapper subsystem 502 of FIG. 5 fails or if the media server fails, a network operator will be alerted. The term component means all the pieces of the hardware and software that are used to make a device.

The SRP controller 412 uses a MIB process to retrieve all MMS hardware component information and to determine if the hardware components are functioning properly and to collect operational measures on all MMS components, such as the cpu capacity, packet utilization, packets lost, local disk utilization, and other hardware measurements that relate to streaming service. The SRP controller 412 also monitors SRP and stream caster software processes that are key to the delivery of streaming media. For example, if the viewer session controller 306 of FIG. 3 fails, the SRP controller 412 will alert a network operator.

The storage controller 414 uses an MIB to determine if all storage hardware components are functioning properly and to collect operational measures on all storage hardware components. For example, if the storage capacity exceeds desired thresholds, the storage controller 414 alerts a network operator and/or an automated clean up procedure will be activated.

The signaling controller 416 uses signaling messages to determine if all hardware components related to signaling or data transmission from the MMS 110A are functioning properly and to collect operational measures on all such components, number of streaming sessions activated by media within the last five minutes, number of sessions dropped within the period, reason the session was dropped, and other operational measures specific to media. The communication controller 416 determines the quality of service of any existing virtual private network (VPN) signaling network used by or with the MMS 110A. The signaling controller 416, for example, traces the data path from the RTSMS 106 to the MMS 110A and records data transmission packet latency and packet loss.

FIG. 5 depicts an exemplary embodiment of a signal wrapper subsystem of the present invention. The signal wrapper subsystem (SWS) 502 of FIG. 5 comprises a session controller 504, a signal proxy 506, a stream proxy 508, a media server 510, a media log 512, and a data collector 514. The media log 512 and the data collector 514 communicate with the LDSTS 516 of the stream caster.

The session controller 504 monitors and stores session information for the stream caster 206A. The session controller 504 receives reservation data from the SRP 202 and transmits the reservation data, including the reservation identification, to the signal proxy 506. The session controller 504 monitors the sessions for security, fail over management, and viewer session state model transition.

The session controller 504 receives signaling instructions from the SRP 202 regarding reservations for a media request. This reservation data is transmitted to the signal proxy 506 for allowing or disallowing a session.

The session controller 504 can communicate directly with the media server 510 to obtain the status of the media server. Thus, the session controller 504 can determine if the media server 410 is healthy or if the media server is in a fail over condition or is in another error condition.

The session controller 504 monitors the media server logs and data collected from the signal proxy 506. The session controller 504 uses the information to determine average bandwidth used for current media streaming, frames lost, and packet loss on a per session basis. The session controller 504 receives raw signaling data from the signal proxy 506 and the stream proxy 508 if requested. The raw signaling data, the media server log data, and any other collected data is transmitted to the SRP 202.

The signal proxy 504 operates as a buffer between the viewer 116 and the media server 510. The signal proxy 506 receives the raw signaling from the viewer and processes the raw signaling. The signal proxy 506 can transmit the raw signaling data to the data collector 514 for storage and use in creating signaling logs. The signal proxy 506 also transmits raw signaling data to the session controller 504 for use in session monitoring and for use in transmission to the viewer session controller 306 of the SRP 202A to maintain the state model and the state changes for the state model.

In addition, the signal proxy 506 receives the reservation data, including the reservation identification. The signal proxy 506 also receives within the raw signaling messages from the viewer 116 the reservation data, including its reservation identification. The signal proxy 506 processes the reservation data from session controller 504 and the viewer 116 to determine if the reservation data from the viewer is valid. Thus, the signal proxy 506 authenticates whether or not the valid reservation identification is received from the viewer. If a valid reservation identification is received from the viewer 116, the signal proxy 506 will transmit the signaling messages to the media server 510. If the reservation identification is not valid, the signal proxy 506 will terminate the session with the viewer 116.

The signal proxy 506 also collects and transmits raw signaling for the signaling logs to the data collector 514. This collection of the raw signaling enables the data collector 514 to build a signaling log that is independent of any logs produced by the media server 510. This concept is important in being able to build signaling logs identifying the reservation and the viewer 116. Essentially, this information can be used to format any type of signaling log to track each session and each state for a requested reservation.

The signal proxy 506 enables the viewer to use any media server. If the media server 510 is streaming media to the viewer 116 thereby transmitting signaling messages to the viewer, and if the media server fails, the signal proxy 506 can transmit the signaling messages to a second media server selected by the SRP to enable the second media server to stream the media to the viewer. Thus, the signal proxy 506 can enable transparently replacing the media server 510 with a second media server so that the viewer 116 is unaware of the change.

The signal proxy 506 can use any control protocol. In one embodiment, the signal proxy 506 uses the real-time transport control protocol (RTCP).

The stream proxy 508 operates as a buffer between the viewer 116 and the media server 510. The stream proxy 508 receives media from the media server 510 and transmits the media to the viewer 116.

The stream proxy 508 may have several public IP addresses to which the viewer 116 can connect. In addition, the stream proxy 508 has a private IP address to which only the media server 510 or another media server within the stream caster 206A can connect. The private IP address is purely internal to the stream caster 206A. The public IP addresses of the stream proxy 508 are purely external to the stream caster 206A and the MMS 110 as a whole. Thus, the only way that a potential viewer 116 can connect to the media server 510 is through the stream proxy 508. This stream proxy 508 concept provides an additional level of security to the stream caster 206A and the MMS 110 as a whole and prevents unauthorized viewers from connecting to a media server.

The concept of the stream proxy 508 also enables a viewer to connect to any media server within the stream caster 206A. Thus, if the media server 510 fails, the viewer 116 is transparently connected to a second media server. The second media server merely is instructed to bind to the private IP address of the stream proxy 508. The viewer 116 never knows that another media server is streaming the media.

The stream proxy 508 can use any transport protocol. In one embodiment, the stream proxy 508 uses the real-time transport protocol (RTP).

In some instances, the stream proxy 508 receives signaling from the viewer 116. In those instances, the stream proxy 508 transmits the signaling to the media server 510. In addition, the stream proxy 508 can be configured to transmit the signaling to the session controller 504. This includes the RTSP defined messages. The stream proxy 508 can be configured to leave out the transmission of certain types of the messages to the session controller 504.

The media server 510 streams the media to the viewer 116, usually through the stream proxy. It will be appreciated, that the media is streamed via the packet switch 214 of FIG. 2. The media server 510 retrieves the requested media from the media storage 210 or 212 (see FIG. 2) via an IP call.

The media server 510 processes signaling received from the viewer 116, such as in-band signaling, for viewer events. The media server 510 processes this signaling and affects the viewer event control through the streaming. For example, the media server 510 may receive signaling for a pause. In this example, the media server 510 stops streaming the media until a play or a resume is received from the viewer 116. In another example, the media server 510 receives signaling identifying a rewind. In this example, the media server 510 retrieves media previously sent and starts restreaming from that point forward.

The media server 510 generates media logs. The media logs identify the media transmitted, the bytes sent, the capacity used, and viewer events. The media logs also contain the IP address of the viewer 116 and the URL that the viewer used to obtain the requested media. Because the URL in this instance contains the reservation number of the request, the media logs also will identify the reservation number. In this way, the media server logs also can be collated or otherwise tracked using the reservation number.

The media log 512 temporarily stores the media logs generated by the media server 510. The media log 512 transmits the media logs to the LDSTS 516 of the stream caster 206A.

The data collector 514 collects raw signaling from the signal proxy 506. The data collector 514 processes the raw signaling data into the signaling logs and transmits the signaling logs to the LDSTS 516 of the stream caster 206A.

The SWS 502 of FIG. 5 operates as follows. In a first example, the SRP 202 transmits a message to the session controller 504 to determine if the stream caster 502 can provide the requested media. The session controller 504 transmits an acknowledgment back to the SRP 202 that it can provide the requested media. Other processing and operations occur.

The SRP 202 transmits reservation data to the session controller 504. The session controller transmits the reservation data, including the reservation identification, to the signal proxy 506. The viewer 116 transmits signaling to the signal proxy 506, including the reservation identification.

The signal proxy 506 compares the reservation data received from the session controller 504 with the reservation information received from the viewer 116. In this example, the signal proxy 506 validates the reservation identification received from the viewer 116 and enables a session to the media server 510.

The signal proxy 506 transmits a public IP address of the stream caster 206A to the viewer 116. When the signal proxy 506 authenticates the reservation and selects the media server 510 to provide requested media streaming, the signal proxy 506 passes the IP address of the viewer 116 to the media server 510. When the media server 510 is enabled by the signal proxy 506 to stream the media, the media server 510 is bound to the stream proxy 508.

The viewer 116 transmits a play message to the media server 510 via the signal proxy 506. On response, the media server 510 streams the media to the viewer 116 via the stream proxy 508. The stream proxy 508 pushes the media to the viewer 116. In other examples, other protocols may be used. In this example, the signal proxy 506 uses the RTCP protocol. In other examples, other protocols may be used.

When the media server 510 streams the media through the stream proxy 508, the media server transmits packets to the private IP address of stream caster.

It will be appreciated that messages transmitted between the signal proxy 506 and the media server 510 occur through the TCP/IP stack.

While the media server 510 is streaming media, if a viewer event occurs, the viewer 116 transmits signaling for the viewer event to the signal proxy 506. The signal proxy transmits the signaling for that viewer event to the media server 510. The media server 510 then operates the streaming in accordance with the requested viewer event signaling. For example, the viewer 116 may transmit signaling for a pause to the media server 510 via the signal proxy 506. Upon receiving the pause request, the media server 510 will stop streaming media to the viewer 116 via the stream proxy 508.

When the viewer 116 has received all of the media, the viewer will transmit a tear down message to the media server 510 via the signal proxy 506. In this example, when the signal proxy 506 receives the tear down message from the viewer 116, signal proxy will wait a configurable period of time before shutting down the port from which the stream proxy streams the media. In this example, the period is 15 seconds. When the 15 seconds times out, the signal proxy 506 shuts down the port. When the media server 510 receives the tear down message, the media server expects to cease streaming the media. If another set up message is not received, the media server 510 ceases operating.

When the request is received by the signal proxy 506 from the viewer 116, the signal proxy transmits the request initiation data to the data collector 514 for use in creating the signal logs and to the session controller 504 for use in the state model and recording the state model changes in the SRP 202. Throughout the streaming period between the media server 510 and the viewer 116, the signal proxy 506 transmits raw signaling to the data collector 514 for recordation and creation of the signaling logs. In addition, the signal proxy 506 transmits the signaling to the session controller 504 for ultimate transmission to the SRP 202 to update the state model and the state changes. In addition, when a viewer event occurs, the signal proxy transmits the raw signaling data for a viewer event to the data collector 514 and to the session controller 504. Likewise, when the session is torn down, the signal proxy 506 transmits the raw signaling to the data collector 514 and notifies the session controller 504 that the session has been torn down.

Upon receiving the signaling data from the signal proxy 506, the session controller 504 transmits the data for the session to the SRP 202 for creation and updating the state model and the state changes. This data includes reception of the reservation identification from the viewer 116, the set up message, the tear down message, and viewer events. The session controller 504 transmits the state model data and state change data to the SRP 202.

In addition, the session controller 504 periodically contacts the media server 510 and requests status identifications. The status identification may include bites lost, packets lost, and packet information. The status information may have been received by the media server 510 from data transmitted from the viewer 116 to the media server 510 either via the signal proxy 506 or back through the stream proxy 508 using the stream proxy protocol. For example, if the stream proxy 508 is using the RTP protocol, signaling is transmitted from the viewer 116 through the stream proxy 508 to the media server 510.

The data collector 514 transmits signaling logs to the LDSTS 516 when the session is initiated, such as when the set up message is transmitted to the signal proxy 506. The data collector 514 also transmits signaling logs at the tear down, upon occurrence of a viewer event, and at regular configurable periods of time. In this example, the data collector 514 is configured to transmit a signaling log to the LDSTS 516 every 5 minutes.

In addition, while the media server 510 is streaming the media to viewer 116, the media log 512 creates media logs and transmits them to the LDSTS 516. In this example, the media log 512 transmits the media server logs at configurable periods of time, such as every 5 minutes. In this example, the media log 512 does not transmit media server logs at set up or on the occurrence of viewer events. The media log 512, however, does transmit a media log to the LDSTS 516 upon tear down.

In another example, the viewer 116 somehow obtains the IP address of the stream caster 206A. The viewer 116 transmits a reservation number to the signal proxy 506. The signal proxy 506 calls the session controller 504 and requests the current reservation data. The session controller 504 transmits the current reservation data to the signal proxy 506. The signal proxy 506 compares the reservation data received from the session controller 504 with the reservation identification received from the viewer 116. The signal proxy 506 determines that the reservation number received from the viewer 116 is not a valid reservation number and terminates the session.

In another example, the media server 510 is streaming media to the viewer 116. In this example, the session controller 504 is monitoring the media server 510 and requesting the status of the media server periodically. The session controller 504 detects a failure in the media server 510. The session controller 504 instructs the signal proxy 506 to re-route the session to a second media server. The signal proxy 506 then transmits the signaling received from the viewer 116 to the second media server. The second media server binds to the stream proxy 508 and its IP address. The second media server continues to stream media to viewer 116 via the stream proxy 508. Signaling transmitted from the viewer 116 to the signal proxy 506, including viewer events, is transmitted to the second media server. If signaling is received by the stream proxy 508 from the viewer 116, including signaling identifying lost packets, the stream proxy 508 transmits that signaling to the second media server. It can be seen, that the viewer 116 has transparently been connected to the second media server, and the viewer is not aware that a second media server is streaming the media. In this example, the second media server is in a stream caster 206A. However, in other examples, the second media server can be in another stream caster or in another MMS.

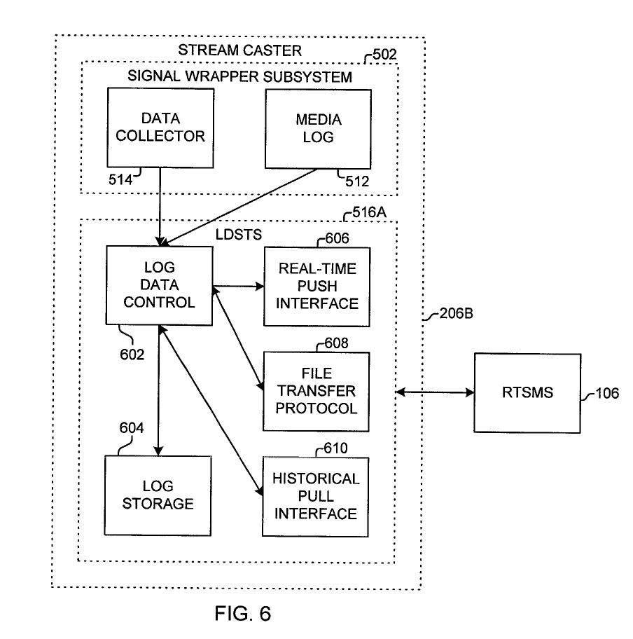

FIG. 6 depicts an exemplary embodiment of an LDSTS for a stream caster of the present invention. The LDSTS 516A of FIG. 6 comprises log data control 602, log storage 604, a real time push interface (RTPI) 606, a file transfer protocol (FTP) interface 608, and a historical pull interface (HPI) 610.

The log data controller 602 receives signaling logs from the data collector 514 and media server logs from the media log 512. The log data controller 602 determines if the logs are to be transmitted from the RTPI 606, the FTP 608, or the HPI 610. The log data controller 602 also determines which logs are to be stored in the log storage 604 and in what format, formats the logs appropriately, and transfers the formatted logs to the log storage. For example, when the media log 512 or the data collector 514 of the SWS 502 logs to the log data controller 602, the log data controller simultaneously safe stores the data to a local stream caster disk device of the log storage 604 and transmits the logs or other data over the RTPI 606 to the RTSMS 106. The log data controller 602 also receives requests for logs made through the FTP interface 608 and the HPI 610. The log data controller 602 controls the retrieval and transmission of the logs and records in the requested format.

The log storage 604 stores signaling logs, media server logs, and other data. The log storage 604 receives logs and other data from the log data controller 602 and the retrieves logs and other records from storage for the log data controller.

The RTPI 606 is used to send real time event data, logs, and records, including the SIBs, to the RTSMS 106. The RTSMS 106 normally will have a private data path open to an NTPI for each MMS to receive such data. The RTPI 606 sends only real time events, such as state changes and viewer events.

The FTP 608 is used by the RTSMS 106 to obtain an entire signaling log file from the stream caster 206B. The FTP 608 transmits a closed signaling log file in its entirety. The FTP 608 is an open system protocol interface for transmitting files between computer systems. The log can be processed on the RTSMS 106 or delivered to customers for inspection.

The HPI 610 is used by the RTSMS 106 to obtain records that are lost or that were not received in real time. The HPI 610 enables the RTSMS 106 to provide the last known good record, either by record identification or time stamp, and the HPI 610 will retrieve from the SIB log 604 and transmit every record from that point on to the RTSMS. The HPI 606 also will accept from the RTSMS 106 a start and stop range for the records, using either record identifications or time stamps.

Those skilled in the art will appreciate the variations from the specific embodiments disclosed above are contemplated by the invention. The invention should not be restricted to the above embodiments, but should be measured by the following claims.

What is claimed is:

1. A system for streaming media comprising:
a stream routing processor configured to receive reservation data comprising a valid reservation identification and to transmit the valid reservation identification; and
a stream caster configured to receive a reservation identification, to receive the reservation data identifying the valid reservation identification from the stream routing processor, to validate the reservation identification using the valid reservation data, and, if valid, to stream at least partially the requested media.

2. The system of claim 1 further comprising a plurality of stream casters configured to stream media from the system.

3. The system of claim 1 further comprising a switch controller configured to monitor a state of a system resource.

4. The system of claim 1 further comprising media storage configured to store the media.

5. The system of claim 1 further comprising a packet switch configured to transmit packets containing the media from the system.

6. The system of claim 5 wherein the packet switch comprises an internet protocol packet switch.

7. The system of claim 1 wherein the stream caster further is configured to transmit at least one information block comprising the reservation identification and at least one member of a group comprising a session initiation, a session termination, and a viewing event for a session.

8. The system of claim 7 wherein the session comprises at least one member of a group comprising an internet protocol session and a broadband connection.

9. The system of claim 1 wherein the stream routing processor further is configured to maintain a reservation state model comprising the reservation identification and at least one member of a group comprising a session initiation, a session termination, and a viewing event.

10. A switch for streaming media comprising:
a stream routing processor configured to receive signaling inquiring if the switch can stream requested media, to determine if the switch is configured to stream the requested media, and, if so to receive reservation data comprising a valid reservation identification; and
a stream caster configured to receive a reservation identification, to receive from the stream routing processor the reservation data identifying the valid reservation identification, to validate the reservation identification using the valid reservation data, and, if validated, to stream at least partially the requested media.

11. The switch of claim 10 wherein the stream routing processor further is configured to monitor a state of the switch.

12. The switch of claim 11 wherein the state comprises at least one member of a group comprising available bandwidth, required bandwidth for the requested media, version compatibility, storage capacity, and operating mode.

13. The switch of claim 10 wherein the stream routing processor further is configured to monitor a status of a media server.

14. The switch of claim 10 wherein the stream routing processor further is configured to transmit signaling to a routing processor identifying that the switch can provide the requested media

15. The switch of claim 10 wherein the stream routing processor further is configured to record a state change in a state model for a session.

16. The switch of claim 15 wherein the state change comprises at least one member of a group comprising the requested media, a streamed media, the reservation identification, duration of media streamed, and a viewing event.

17. The switch of claim 10 wherein:
the stream caster comprises a first media server and a second media server;
the first media server is configured to stream a first portion of the requested media; and
the second media server is configured to stream a second portion of the requested media.

18. The switch of claim 17 wherein stream routing processor is configured to record a state change comprising an identification of the first media server streaming the first portion and the second media server streaming the second portion.

19. The switch of claim 10 wherein:
the switch comprises a second stream caster;
the stream caster is configured to stream a first portion of the requested media; and
the second stream caster is configured to stream a second portion of the requested media.

20. The switch of claim 19 wherein stream routing processor is configured to record a state change comprising an identification of the stream caster streaming the first portion and the second stream caster streaming the second portion.

21. The switch of claim 10 wherein the stream routing processor is configured to transmit signaling to, and receive signaling from, the stream caster to determine if the stream caster is configured to stream the requested media.

22. The switch of claim 21 wherein the stream routing processor determines that the stream caster is configured to stream the requested media and the stream routing processor is configured to transmit the reservation data to the stream caster and to transmit an acknowledgement to a routing processor.

23. The switch of claim 10 wherein the stream routing processor further is configured to transmit a message to the stream caster, to receive a response from the stream caster, and to process the response to determine if the stream caster is configured to stream the requested media.

24. The switch of claim 10 wherein the reservation data comprises a play list and the stream routing processor is configured to transmit the play list to the stream caster if the stream caster.

25. The switch of claim 10 wherein the switch is configured to communicate with a routing processor and wherein the stream routing processor is configured to transmit signaling to, and receive signaling from, the routing processor.

26. The switch of claim 10 wherein the stream routing processor is configured to communicate out-of-band to a broadband device.

27. The switch of claim 26 wherein the broadband device comprises a set top box.

28. The switch of claim 10 wherein the stream caster further is configured to accept a session upon receiving a valid reservation identification.

29. The switch of claim 28 wherein the stream caster is configured to process signaling received in the session to affect the media streaming.

30. The switch of claim 29 wherein the signaling comprises at least one member of a group comprising a setup, a teardown, a status message, and a viewing event.

31. The switch of claim 29 wherein the session comprises at least one member of a group comprising an internet protocol session and a broadband connection.

32. The switch of claim 10 wherein the stream caster is configured to report a state change to the stream routing processor.

33. The switch of claim 10 further comprising a switch controller configured to monitor a state of a switch resource.

34. The switch of claim 33 wherein the resource comprises a hardware component.

35. The switch of claim 33 wherein the switch controller is configured to report to the stream routing processor at least one member of a group comprising a service impacting event and a capacity impacting event.

36. The switch of claim 10 further comprising a media storage configured to store the media.

37. The switch of claim 10 further comprising a packet switch configured to transmit packets containing the media from the switch.

38. The switch of claim 37 wherein the packet switch is configured for multicasting of a live event or a simulated live event.

39. The switch of claim 10 further comprising a packet switch configured to transmit packets containing signaling within the switch.

40. The switch of claim 39 wherein the packet switch comprises an internet protocol packet switch.

41. The switch of claim 39 wherein the packet switch is configured to transmit and receive out-of-band signaling.

42. The switch of claim 10 wherein the reservation data comprises a play list.

43. The switch of claim 10 wherein the stream routing processor is configured to transmit and receive signaling in-band.

44. The switch of claim 10 wherein the stream routing processor is configured to transmit and receive signaling out-of-band.

45. A system for streaming media to a viewer comprising:
a stream caster configured to accept a session from the viewer to stream at least partially the requested media upon receiving and validating a reservation identification using a valid reservation identification; and
a stream routing processor configured to determine if the stream caster is configured to stream the requested media, and, if so, to receive reservation data comprising the valid reservation identification and to transmit the valid reservation identification to the stream caster.

46. The system of claim 45 wherein the stream routing processor comprises a switch load controller configured to communicate signaling to and from the stream caster.

47. The system of claim 46 wherein the signaling comprises the reservation data.

48. The system of claim 45 wherein the stream routing processor comprises a switch load controller configured to communicate signaling to and from a routing processor.

49. The system of claim 45 wherein the stream routing processor comprises a switch load controller configured to communicate with a resource manager to determine if the stream caster has a resource available to stream the requested media.

50. The system of claim 49 wherein the resource comprises at least one member of a group comprising a media server, processing capacity, and bandwidth.

51. The system of claim 45 wherein the stream routing processor comprises a switch load controller configured to record a status of at least one event or at least one device in the system.

52. The system of claim 45 wherein the status comprises at least one member of a group comprising an active media stream, not to exceed capacity, and current capacity.

53. The system of claim 45 wherein the stream routing processor comprises a switch resource manager configured to monitor and to record status of resources in the system.

54. The system of claim 53 wherein the resources comprise at least one member of a group comprising a stream caster, a media player, bandwidth, current capacity, and not to exceed capacity.

55. The system of claim 45 wherein the stream routing processor comprises a viewer session control configured to maintain a reservation state model for each attempted reservation using the reservation identification.

56. The system of claim 45 wherein the stream routing processor comprises a viewer session control configured to maintain a reservation state model for a session and to receive from the stream caster and record each state change, wherein the state model identifies the session using the reservation identification.

57. The system of claim 56 wherein the state change comprises at least one member of a group comprising a setup, a teardown, and a viewing event.

58. The system of claim 45 wherein the stream routing processor comprises a viewer session control configured to create at least one information block for a session.

59. The system of claim 58 wherein the information block comprises the reservation identification, an identification of streamed media, a presentation identification, a media server, the stream caster, a media player, and a data packet path.

60. The system of claim 45 wherein the stream routing processor comprises a log data system configured to transmit log data from the system.

61. The system of claim 60 wherein the log data comprises at least one member of a group comprising an information block and a signaling log.

62. The system of claim 60 wherein the log data comprises at least one member of a group comprising a historical pull interface and a real time push interface.

63. The system of claim 45 wherein the stream caster comprises a signal wrapper subsystem configured to transmit session and state information to the stream routing processor and to receive and processes signaling from the stream routing processor.

64. The system of claim 45 wherein the stream caster comprises a signal wrapper subsystem configured to generate signaling logs and media server logs.

65. The system of claim 45 wherein the stream caster comprises a signal wrapper subsystem configured to receive and process signaling from the viewer and to transmit signaling and media to the viewer.

66. The system of claim 65 wherein the signal wrapper subsystem comprises a session controller configured to monitor and store session information and to transmit session information to the stream routing processor.

67. The system of claim 65 wherein the signal wrapper subsystem comprises a session controller configured to obtain status information from a media server.

68. The system of claim 65 wherein the signal wrapper subsystem comprises a session controller configured to transmit and receive signaling to and from the stream routing processor, including the valid reservation identification.

69. The system of claim 65 wherein the signal wrapper subsystem comprises a signal proxy configured to receive and process raw signaling from the viewer.

70. The system of claim 69 wherein the signal wrapper subsystem comprises a signal proxy configured to transmit the raw signaling for use by the stream processor to maintain a state model.

71. The system of claim 65 wherein the signal wrapper subsystem comprises a signal proxy configured to receive the reservation data, including the valid reservation identification, and to validate the reservation identification received from a viewer using the valid identification reservation.

72. The system of claim 65 wherein the signal wrapper subsystem comprises a signal proxy configured to accept or deny an attempted session based on validating the received reservation identification.

73. The system of claim 65 wherein the signal wrapper subsystem comprises a signal proxy configured to receive signaling for a session and to transmit the signaling to a media server.

74. The system of claim 73 wherein the signal proxy further is configured to transmit the signaling to another media server if the media server cannot stream the media.

75. The system of claim 65 wherein the signal wrapper subsystem comprises a stream proxy configured to bind a media server to a public internet protocol address.

76. The system of claim 65 wherein the signal wrapper subsystem comprises a stream proxy configured to transmit media streamed from a media server to the viewer.

77. The system of claim 76 wherein the stream proxy further is configured to transmit media streamed from another media server to the viewer if the media server is not able to stream the media.

78. The system of claim 65 wherein the signal wrapper subsystem comprises a stream proxy configured to receive signaling from the viewer and to transmit the signaling to a media server.

79. The system of claim 78 wherein the signaling comprises a status of the streaming media.

80. The system of claim 65 wherein the signal wrapper subsystem comprises a media server configured to stream media to the viewer.

81. The system of claim 80 wherein the media server further is configured to generate at least one media log comprising the reservation identification.

82. The system of claim 65 wherein the signal wrapper subsystem comprises a media log configured to store media logs generated by a media server.

83. The system of claim 65 wherein the signal wrapper subsystem comprises a data collector configured to collect raw signaling and to process the raw signaling to create at least one signaling log.

84. The system of claim 83 wherein data collector further is configured to transmit the signaling log to a log data system.

85. The system of claim 45 wherein the stream caster comprises log data system configured transmit from the system at least one member of a group comprising signaling logs and media logs.

86. The system of claim 85 wherein the log data system comprises a log data control configured to receive the signaling logs, to control transmitting the signaling logs from the system, and to control storage, if any, of the signaling logs.

87. The system of claim 85 wherein the log data system comprises a log storage configured to store the signaling logs.

88. The system of claim 85 wherein the log data system comprises a real-time push interface configured to transmit the signaling logs from the system in real time.

89. The system of claim 85 wherein the log data system comprises a historical pull interface configured receive a request for signaling logs and to transmit requested signaling logs.

90. The system of claim 85 wherein the log, data system comprises a file transfer protocol interface configured to transmit a closed signaling log from the system.

91. The system of claim 45 further comprising a broadband service controller configured to monitor a broadband connection to determine if the broadband connection is active.

92. The system of claim 45 further comprising a broadband service controller configured to monitor a broadband connection to determine if the broadband connection has a quality of service problem.

93. The system of claim 45 further comprising a broadband service controller configured to record a state of the broadband connection.

94. The system of claim 93 wherein the broadband service controller comprises a circuit database configured to store a status of a broadband connection.

95. The system of claim 45 further comprising a human machine interface configured to enable human access to configure the system.

96. The system of claim 95 wherein the human machine interface comprises at least one member of a group comprising a web browser, a graphical based terminal session, and a command interface.

97. The system of claim 45 further comprising a network manager configured to monitor status of component in the system.

98. The system of claim 97 wherein the network manager comprises a stream caster controller configured to monitor and to report status of the stream caster.

99. The system of claim 97 wherein the network manager comprises an SRP controller configured to monitor and to report status of the stream routing processor.

100. The system of claim 97 wherein the network manager comprises a media storage controller configured to monitor and to report status of a media storage.

101. The system of claim 97 wherein the network manager comprises a signaling controller configured to monitor and to report status of a signaling component.

102. A switch for streaming media to a viewer comprising:
a stream caster configured to accept a session from the viewer to stream at least partially the requested media upon receiving and validating a reservation identification using a valid reservation identification;
a stream routing processor configured to determine if the stream caster is configured to stream the requested media, and, if so, to receive reservation data comprising the valid reservation identification and to transmit the valid reservation identification to the stream caster; and
a switch controller configured to monitor the stream caster and to notify the stream routing processor of a status of the stream caster.

103. A switch for streaming media to a viewer comprising:
a streaming device comprising:
a media server configured to stream at least partially the requested media for a session;
a signal proxy configured to accept the session based on validating a reservation identification received from the viewer and to communicate signaling between the viewer and the media server if the session is accepted; and
a stream proxy configure to transmit media streamed from the media server to the viewer.

104. The system of claim 103 wherein the signal proxy further is configured to receive reservation data, including a valid reservation identification, and to validate the reservation identification received from the viewer using the valid identification reservation.

105. The system of claim 103 wherein the signal proxy further is configured to transmit the signaling to another media server if the media server cannot stream the media.

106. The system of claim 103 wherein the stream proxy further is configured to transmit media streamed from another media server to the viewer if the media server is not able to stream the media.

107. A method for streaming media from a switch comprising:
determining if a stream caster is configured to stream requested media;
receiving reservation data comprising a valid reservation identification at the stream caster; and
accepting a session to stream at least partially the requested media upon receiving and validating a reservation identification using the valid reservation identification.

108. The method of claim 107 wherein the determining step comprises transmitting a message to the stream caster inquiring if the stream caster is configured to stream the requested media and receiving a another message from the stream caster at the stream routing processor acknowledging the inquiry.

109. The method of claim 108 further comprising transmitting a third message to a routing processor identifying the stream caster as being configured to stream the requested media and identifying an address of the stream caster.

110. The method of claim 109 further comprising receiving at the stream routing processor from the routing processor a fourth message comprising the reservation data.

111. The method of claim 107 wherein the address comprises an internet protocol address.

112. The method of claim 107 further comprising receiving the reservation identification at an address of the stream caster and, if validated, accepting the session at the address.

113. The method of claim 112 wherein the address is transmitted from the stream routing processor after the stream routing processor determined that the stream caster is configured to stream the requested media.

114. The method of claim 107 further comprising receiving a setup message at the stream caster and acknowledging the setup message.

115. The method of claim 107 further comprising streaming the requested media, at least partially.

116. The method of claim 115 further comprising receiving a viewing event and changing the requested media streaming accordingly.

117. The method of claim 107 further comprising using a packet switch to communicate between the stream routing processor and the stream caster.

118. The method of claim 107 further comprising using a packet switch to transmit requested media from the stream caster.

119. The method of claim 107 further comprising receiving at the stream caster in-band signaling.

120. The method of claim 107 further comprising receiving at the stream routing processor out-of-band signaling.

121. The method of claim 107 further comprising using in-band signaling to communicate with a viewer

122. The method of claim 107 further comprising using out-of-band signaling to communicate with a viewer.

123. The method of claim 107 further comprising receiving a teardown message at the stream caster and terminating the session.

124. The method of claim 107 further comprising transmitting at least one signaling log from the stream caster, the signaling log comprising the reservation identification.

125. The method of claim 124 wherein the signaling log comprises at least one member of a group comprising setup data, termination data, and a viewing event.

126. The method of claim 107 further comprising transmitting at least one information block from the stream routing processor, the information block comprising the reservation identification.

127. The method of claim 126 wherein the information block comprises at least one member of a group comprising setup data, termination data, a viewing event, a media server identification, and an identification of streamed media.

128. The method of claim 107 further comprising transmitting a plurality of information blocks from the stream routing processor, the information blocks each comprising the reservation identification.

129. The method of claim 128 further comprising transmitting the information block at the occurrence of at least one member of a group comprising setup, termination, a viewing event, a configurable period of time.

130. A method for streaming media from a switch comprising:
receiving at a stream caster reservation data comprising a valid reservation identification; and
terminating an attempted session to stream requested media upon receiving and invalidating a reservation identification using the valid reservation identification.

131. The method of claim 130 further notifying a stream routing processor that the stream caster received an invalid reservation identification and that the attempted session was terminated.

132. A method for streaming requested media from a switch comprising:
receiving signaling inquiring if the switch is configured to stream the requested media;
determining if the switch is configured to stream the requested media, and, if so, acknowledging the inquiry;
receiving reservation data comprising a valid reservation identification;
receiving a reservation identification;
validating the reservation identification using the valid reservation data, and, if validated, streaming at least partially the requested media.

133. A method for streaming media to a viewer comprising:
determining if a streaming device is configured to stream requested media, and, if so, receiving reservation data comprising a valid reservation identification and transmitting the valid reservation identification; and
accepting a session from the viewer at the streaming device to stream at least partially the requested media upon receiving and validating a reservation identification using the valid[ reservation identification.

134. A method for streaming media from a switch comprising:
determining at a stream routing processor if a streaming device is configured to stream requested media;
receiving reservation data comprising a valid reservation identification and transmitting the valid reservation identification to the streaming device;
accepting a session to stream at least partially the requested media upon receiving and validating a reservation identification using the valid reservation identification; and
monitoring the streaming device and notifying the stream routing processor of a status of the streaming device.

135. A method for streaming requested media to a viewer comprising:
accepting a session based on validating a reservation identification received from the viewer;
streaming the requested media from the media server;
proxying media streamed from the media server to the viewer; and
proxying signaling between the viewer and the media server if the session is accepted.

136. A method for streaming requested media comprising:
determining if at least one stream caster is configured to stream the requested media;
receiving reservation data comprising a valid reservation identification; validating a reservation identification using the valid reservation identification; and
accepting a plurality of parallel sessions to simultaneously stream at least partially the requested media.

137. A method for streaming requested media from a switch comprising:
determining if a plurality of stream casters are configured to stream at least a portion of the requested media;
receiving reservation data comprising a valid reservation identification; validating a reservation identification using the valid reservation identification; and
streaming simultaneously in a plurality of parallel sessions at least partially the portion of the requested media.

138. A method for streaming requested media comprising:
determining if at least one stream caster is configured to stream the requested media;
receiving reservation data comprising a valid reservation identification;
validating a reservation identification using the valid reservation identification; and
streaming simultaneously in a plurality of parallel sessions at least partially a portion of the requested media.

139. The method of claim 138 further comprising streaming simultaneously in the plurality of parallel sessions at least partially the portion of the requested media from one stream caster.

140. The method of claim 138 further comprising streaming simultaneously in the plurality of parallel sessions at least partially the portion of the requested media from a plurality of stream casters.
